(19) United States
(12) Patent Application Publication
(10) Pub. No.: US 2018/0317520 A1
(43) Pub. Date: Nov. 8, 2018

(54) INSECT PRODUCTS AND METHODS OF MANUFACTURE THEREOF

(71) Applicant: EXO LABS LLC, Brooklyn, NY (US)

(72) Inventors: Jonathan Ali Bouzari, San Franscisco, CA (US); Daniel L. Felder, Healdsburg, CA (US)

(21) Appl. No.: 15/773,448

(22) PCT Filed: Nov. 3, 2016
(86) PCT No.: PCT/US16/60314

§ 371 Date: May 3, 2018

Related U.S. Application Data
(60) Provisional application No. 62/250,400, filed on Nov. 3, 2015.

(51) Int. Cl. A23J 3/34; A23L 13/10; A23K 10/20; A23J 1/00; A23K 10/14; B01D 61/14; A23L 3/40

(52) U.S. Cl. CPC A23J 3/341; A23L 13/10; A23K 10/20; A23J 1/00; A23V 2002/00; B01D 61/145; B01D 61/147; B01D 61/142; A23L 3/40; A23K 10/14

(57) ABSTRACT

Provided are insect products and methods for producing an insect product comprising solid insect particles. Methods for producing an insect product can include providing a dried cricket powder, providing a dried insect, or grinding wet-grinding, or shearing at least one insect into a paste or powder; adding water or an enzyme to the paste or powder to form a slurry; and filtering the slurry to produce an insect product. Methods for producing a chitin product are also provided that include providing a dried cricket powder or grinding, wet-grinding, or shearing at least one whole insect into a paste or powder; adding water or an enzyme to the paste or powder to form a slurry; and filtering the slurry to produce an insect product comprising chitin.

### CROSS-REFERENCE TO RELATED APPLICATIONS

The present application claims the benefit of U.S. Provisional Application Ser. No. 62/250,400 filed 3 Nov. 2015, which is fully incorporated by reference herein for all purposes.

### STATEMENT REGARDING FEDERALLY SPONSORED RESEARCH OR DEVELOPMENT

Not Applicable.

### MATERIAL INCORPORATED-BY-REFERENCE

Not Applicable.

### TECHNICAL FIELD

The present disclosure generally relates to methods of producing insect products.

### BACKGROUND

Conventionally, insects (e.g., crickets) are processed on the market by dry roasting and milling them. This processing creates a powder that is at most 65% protein by dry weight and has a significant amount of non-soluble fiber. This powder is unable to disperse in liquid, and thus, is difficult to incorporate into a wide variety of food products. Additionally, because the protein content is so low, conventional methods to produce protein from insects cannot compete with other protein products (e.g., powders) on the market, which can have greater than 90% protein by dry weight.

### BRIEF SUMMARY

Among the various aspects of the present disclosure is the provision of an insect product and methods of producing the insect product and uses of the insect product.

Briefly, therefore, the present disclosure is directed to insect products; a process for isolating, recovering, or extracting insect products (e.g., proteins or other materials or nutrients); and uses of the insect products which can be used as, for example, substitutes or supplements for human food or animal feed.

The present disclosure includes methods for producing an insect product including: (i) wet-grinding, grinding, or shearing at least one insect into a paste, puree, or powder, providing dried insect powder, or providing at least one dried insect; (ii) diluting the paste, puree, powder, or dried insect with a composition including water forming an insect slurry; (iii) adding a composition including an enzyme into the insect slurry forming an enzyme-containing insect slurry; (iv) microfiltering the enzyme-containing insect slurry, wherein the pore size of the microfiltration membrane is sufficient to retain lipids or insoluble sediment, wherein proteins are collected in the permeate; or (v) ultrafiltering, nanofiltering, or reverse osmosis filtering of the permeate, wherein the pore size of the filter membrane is sufficient to retain proteins and peptides including solid insect matter particles.

The present disclosure also includes methods for producing an insect product including the steps of: (i) providing an insect; (ii) grinding, wet-grinding, or shearing the insect into an insect paste or powder; (iii) diluting the insect paste or powder with a composition including water forming an insect slurry; (iv) adding a composition including an enzyme to the insect slurry forming an enzyme-containing insect slurry; (v) microfiltering the enzyme-containing insect slurry, wherein the pore size of the microfiltration membrane is sufficient to retain lipids and insoluble sediment, wherein proteins are collected in the permeate; or (vi) ultrafiltering, nanofiltering, or reverse osmosis filtering of the permeate, wherein the pore size of the filter membrane is sufficient to retain proteins and peptides.

The present disclosure includes compositions including insect products produced by the above methods.

The present disclosure includes insect product including: a composition derived from at least one insect, including solid insect particles, wherein the insect product has a protein content of about 90% to about 99%; a fat content of about 0% to about 50%; a carbohydrate content of about 0% to about 50%; an ash content of about 0% to about 5%; or the solid insect particles have an average particle size between about 0.001 μm and about 100 μm or between about 0.01 μm and about 10 μm.

In accordance with a further aspect, proteins can pass through the microfiltration filter; insoluble sediment includes chitin; water and small solutes pass through the ultrafiltration, nanofiltering, or reverse osmosis filter, wherein small solute optionally includes ash; or the enzyme is added in a sufficient quantity to solubilize or partially solubilize the insect, hydrolyze proteins, or to digest the protein component of the slurry.

In accordance with yet another aspect, the methods further include drying the permeate to form a dried insect product.

In accordance with yet another aspect, the method further includes heating the slurry and composition including the enzyme for a period of time sufficient to solubilize or partially solubilize the protein present in the insect; liberate the protein from chitin; or liberate the protein from any other macromolecules to which it is bound. In accordance with yet another aspect, the slurry and composition including the enzyme is heated between about 45° C. and 60° C. or heated for about 30 minutes to about 4 hours.

In accordance with yet another aspect, reverse osmosis filtration is used to remove particles less than about 0.005 μm or between about 0.0001 μm and about 0.005 μm; nanofiltration is used to remove particles less than about 0.01 μm or between about 0.0005 μm and about 0.01 μm; ultrafiltration is used to remove particles less than about 0.5 μm or between about 0.007 μm and about 0.5 μm; ultrafiltration filters or membranes can have a pore size between about 1 kDa and about 100 kDa or between about 3 kDa to about 10 kDa; microfiltration is used to remove particles less than about 20 μm or between about 0.07 μm and about 20 μm; microfiltration filters or membranes can have a pore size between about 0.1 μm and about 10 μm or between about 0.1 μm and about 1 μm; or particle filtration is used to remove particles less than about 1000 μm or between about 0.7 μm and about 1000 μm.

In accordance with yet another aspect, the microfilter retains lipids and insoluble sediment or complex carbohydrates, including chitin and proteins pass through; or the reverse osmosis filter, nanofilter, or ultrafilter retains proteins and peptides and water and small solutes, pass through the filter.

In accordance with yet another aspect, the enzyme is selected from one or more of the group consisting of Bromelain (Ananas comorus stem); Papain (Carica papaya); Peptidase (Aspergillus oryzae); Peptidase (Aspergillus melleus); Protease (Aspergillus niger); Protease (Bacillus licheniformis); Protease (Bacillus subtilis); or Protease (Aspergillus oryzae), protease A, or Flavorpro (peptidase).

In accordance with yet another aspect, the slurry includes a neutral enzyme; a protease and peptidase cocktail; a protease from Aspergillus oryzae at a strength of 800,000 HUT/g; or a peptidase Aspergillus oryzae at a strength of 500 LAP U/g.

In accordance with yet another aspect, the enzyme, protease, peptidase, or protease/peptidase cocktail is present in the slurry at about 0.1% by weight of slurry to about 1.5% by weight of the slurry.

In accordance with yet another aspect, the at least one insect is a whole cricket (Acheta domesticus).

In accordance with yet another aspect, the dried insect powder, insect paste, or insect puree can be diluted with water between a 1:1 dilution and a 1:30 dilution (cricket:water by mass).

In accordance with yet another aspect, the particle size of the dried insect powder, insect puree, or insect paste is about 10 μm-200 μm.

In accordance with yet another aspect, the final insect product includes solid insect particles having an average particle size between about 0.001 μm and about 100 μm or between about 0.01 μm and about 10 μm; solid insect particles present in the insect product are in amount between about 85% and about 100% by weight of the insect product; a protein content of about 90% to about 99%; a fat content of about 0% to about 50%; a carbohydrate content of about 0% to about 50%; or an ash content of about 0% to about 5%.

In accordance with yet another aspect, the method further includes further including adding auxiliary components including spices, herbs, or other natural ground flavorings, cocoa, vanilla, cinnamon, or natural flavor extracts; hydrocolloid gums, optionally, xanthan, guar, or gum acacia; stevia, sucralose, sugar alcohol, or monkfruit extract; salt; or lecithin, mono/diglycerides, or other lipid emulsifiers.

Other objects and features will be in part apparent and in part pointed out hereinafter.

### BRIEF DESCRIPTION OF THE DRAWINGS

Those of skill in the art will understand that the drawings, described below, are for illustrative purposes only. The drawings are not intended to limit the scope of the present teachings in any way.

FIG. 1 is an image depicting a mixture of cricket flour and water prior to digestion with enzymes. The mixture is homogenously dispersed.

FIG. 2 is an image depicting a mixture of cricket flour and water after digestion with proteolytic enzymes. Hydrolysis of protein caused destabilization in suspension, resulting in amber-colored, clear supernatant and dark, turbid sediment phases.

FIG. 3 is an image depicting pre and post enzyme slurries. Two 50 milliliters (ml) aliquots of cricket flour/water slurry taken before enzymatic digestion (the first two tubes from the left) and two 50 ml aliquots of cricket flour/water slurry 10 minutes after enzymatic digestion (the second two tubes from the right). Tube allows visualization of effect of enzyme on suspension as it begins to destabilize.

FIG. 4 is an image depicting two 50 ml aliquots of cricket flour/water slurry taken 30 minutes after enzymatic digestion showing continued settling of sediment.

FIG. 5 is an image depicting (left to right) (i) undigested cricket flour slurry, (ii) retentate from microfiltration, and (iii) two aliquots of clear permeate taken after microfiltration.

FIG. 6 is an image depicting mixing of enzyme, cricket slurry, and deionized (DI) water.

FIG. 7 is an image depicting mixing of enzyme and cricket slurry, specifically, the addition of lyophilized proteolytic enzymes to cricket/water slurry. The slurry was held in jacketed, heated water bath to allow precise temperature control.

FIG. 8 is an image depicting the full process (left to right): Undigested cricket flour slurry, retentate from microfiltration, four aliquots of clear permeate taken after microfiltration, aliquot of permeate after 10 kilodalton (kDa), 5 kDa, and 3 kDa ultrafiltration.

FIG. 9 is an image depicting filtered material, specifically, a top view of aliquot of solid retentate from microfiltration.

FIG. 10A-FIG. 10C are a series of images depicting a collection of permeate during microfiltration.

FIG. 11 is an image depicting a view of a recirculation tube used during ultrafiltration to concentrate product by continuous washing of the filter.

FIG. 12 is an image depicting collection of permeate during ultrafiltration.

FIG. 13 is an image depicting all samples (left to right): undigested cricket flour slurry, retentate from microfiltration, supernatant sample taken from slurry after sedimentation caused by enzymatic hydrolysis prior to microfiltration, permeate taken after microfiltration, aliquot of permeate after 10 kDa, 5 kDa, and 3 kDa ultrafiltration.

FIG. 14-FIG. 30 are a series of data diagrams describing the amino acid analysis of products at various stages of process. The samples are named 3=Sup (sample following enzyme digestion but prior to filtration), 4=Micro Filter (sample after micro filtration), 5=10 kD (sample after microfiltration and ultrafiltration through 10 kD filter), 6=5 kD (sample after microfiltration and ultrafiltration through 5 kD filter), and 7=3 kD (sample after microfiltration and ultrafiltration through 3 kD filter). The ratio of the highlighted values for amino acid concentration for Sample 4 vs. Sample 3 show that the proteins were collected from the filtration at a relatively high yield of 78.6%. Samples 5-7 were collected from the permeate of the ultrafiltration step using successively finer filters. They indicate that even at the 3 kD level, some protein was passing through the filters and thus being lost. This implies that smaller pore sizes can be used to increase protein yield during post-microfiltration, aqueous-based concentration processes.

FIG. 31 is a scatter plot depicting protein hydrolysis as a function of enzyme dosage and time.

FIG. 32 is a scatter plot depicting percent hydrolysis as a function of protein solubility.

FIG. 33 is a scatter plot depicting percent hydrolysis as a function of protease A dosage and time.

FIG. 34 is a scatter plot depicting percent hydrolysis as a function of flavorpro dosage and time.

FIG. 35 is a scatter plot depicting percent hydrolysis as a function of protein solubility.

FIG. 36 is an image of the molecular weight profile of the “raw slurry” sample.

FIG. 37 is an image of the molecular weight profile of the “digested slurry”.

FIG. 38 is an image of the molecular weight profile of the “cleaned” sample.

FIG. 39 is an illustration of various filtration processes known in the art.

FIG. 40 is an illustration of various filtration processes known in the art.

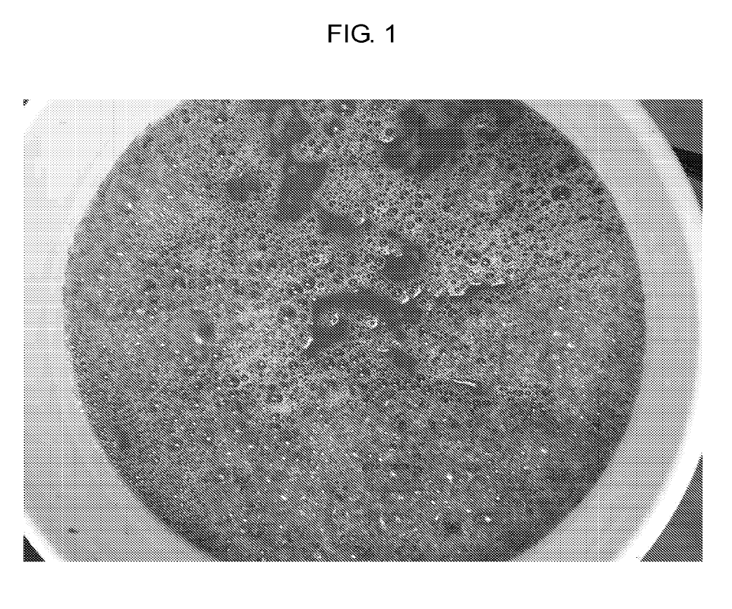

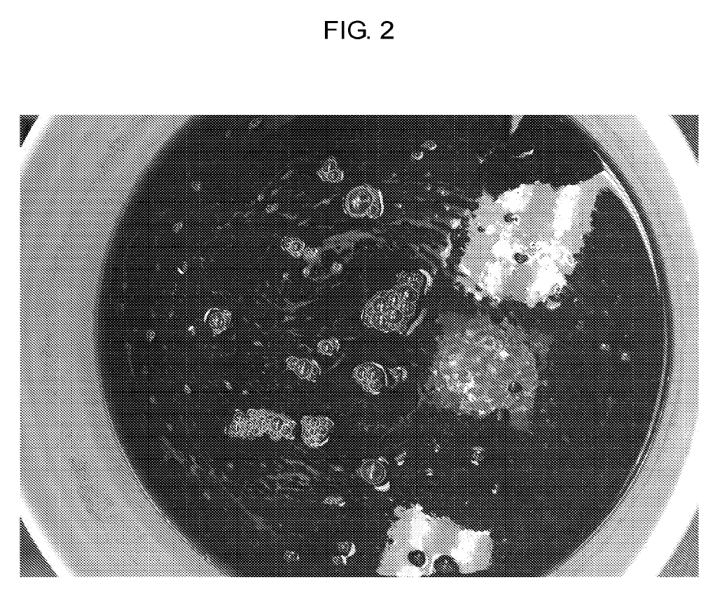

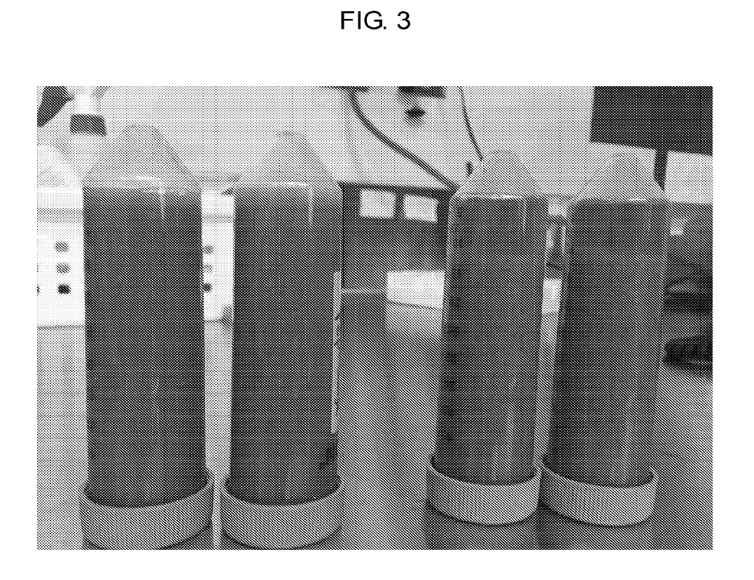

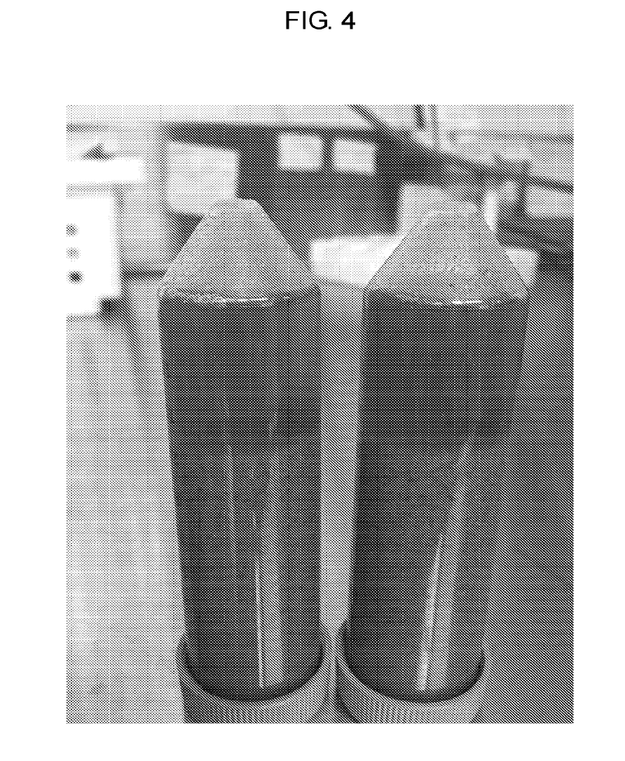

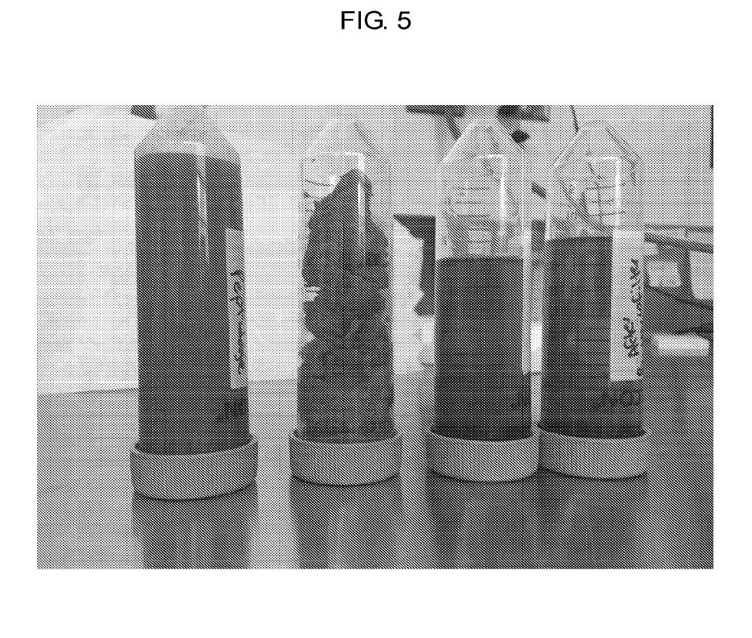

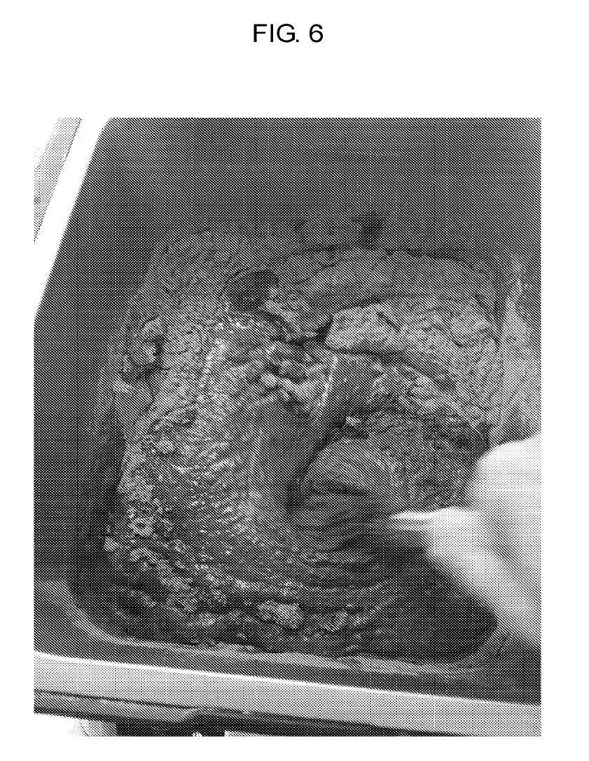

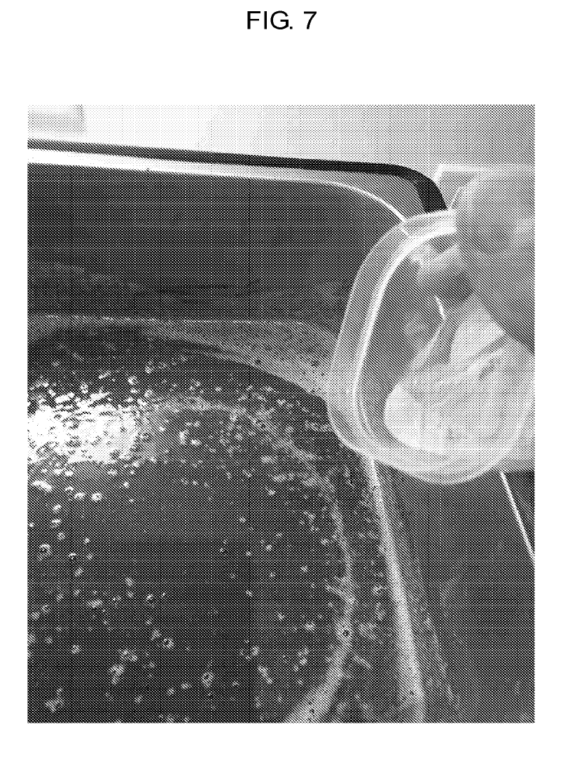

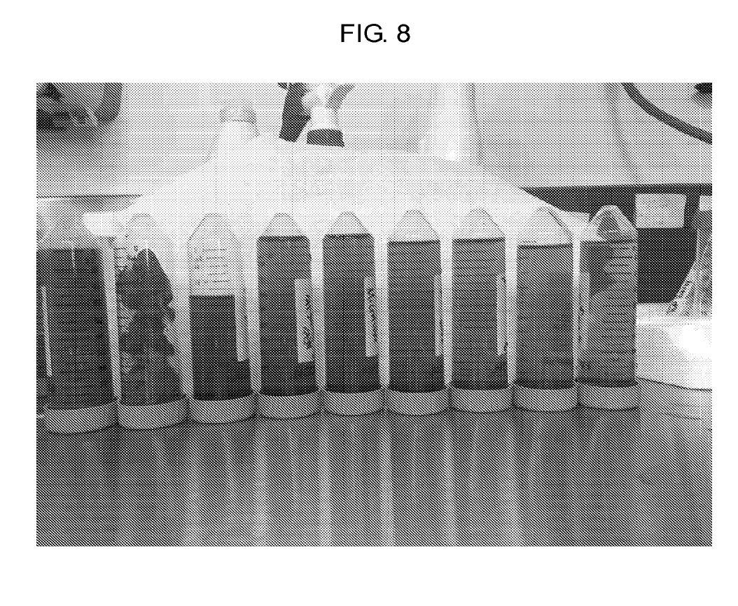

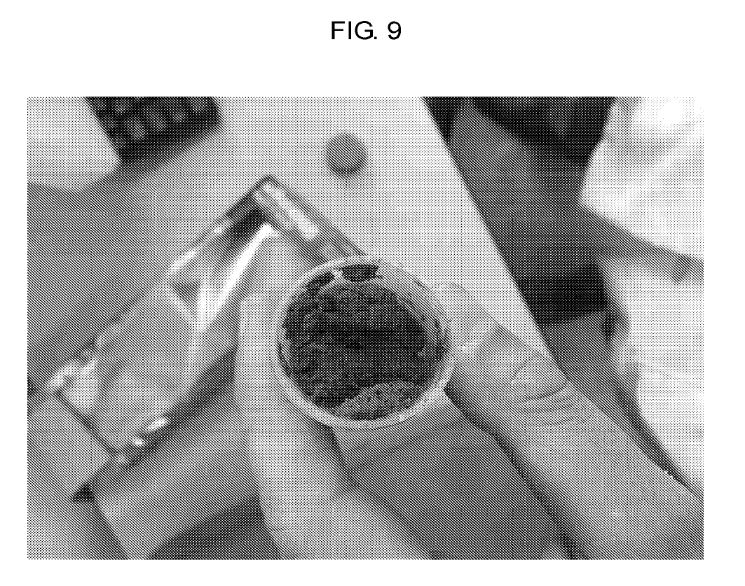

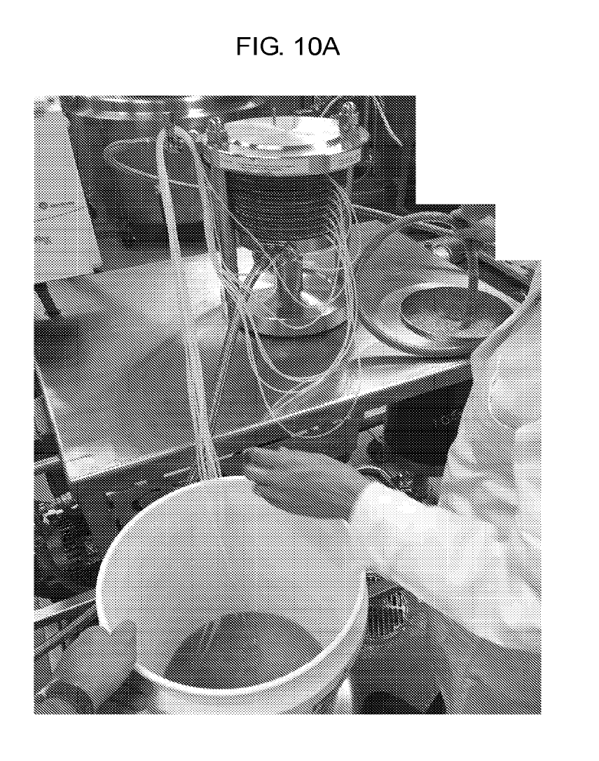

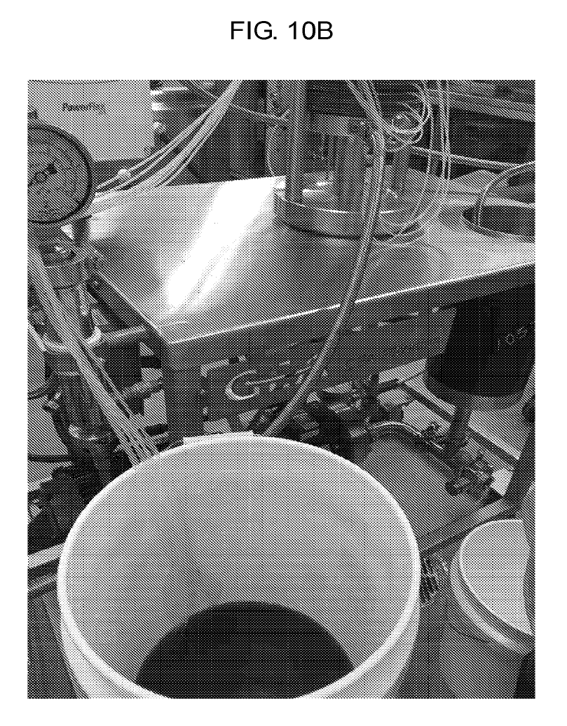

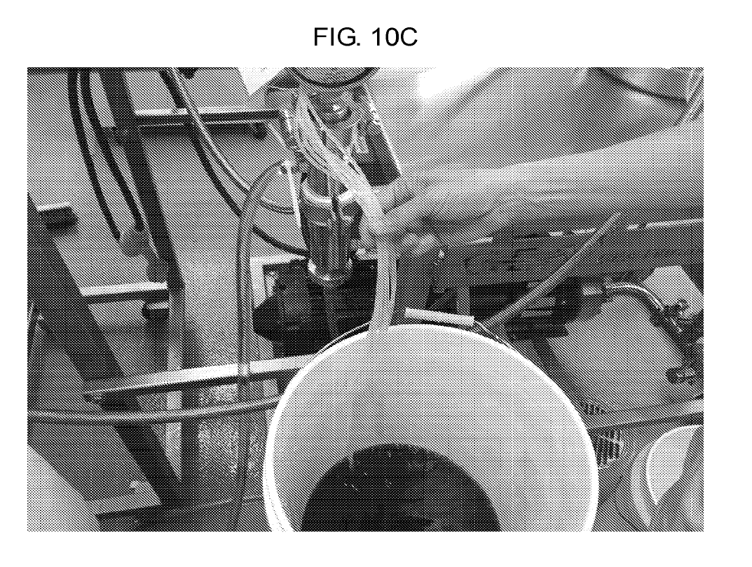

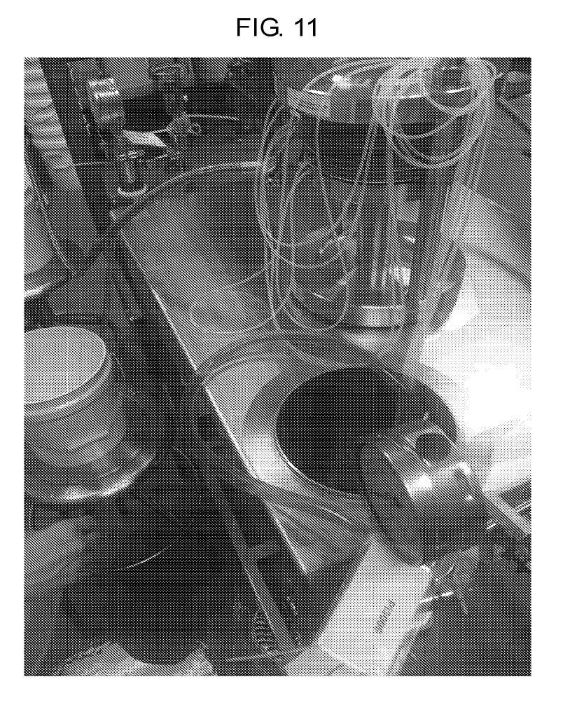

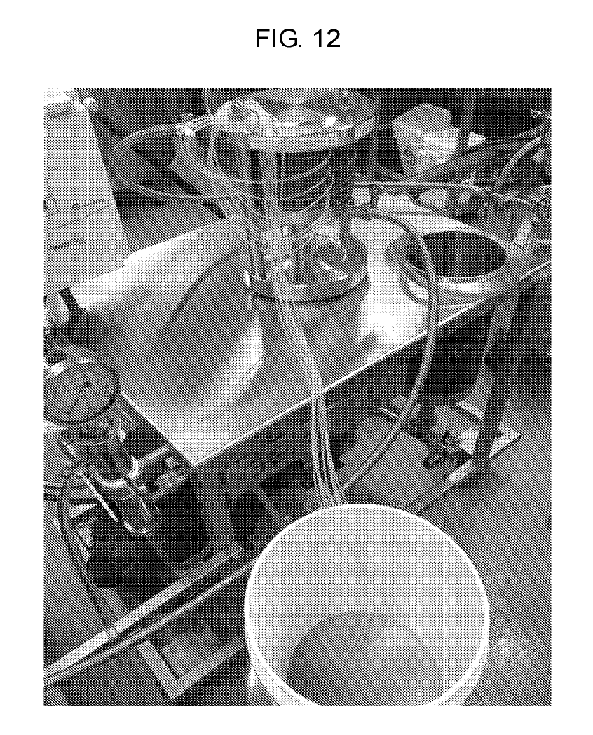

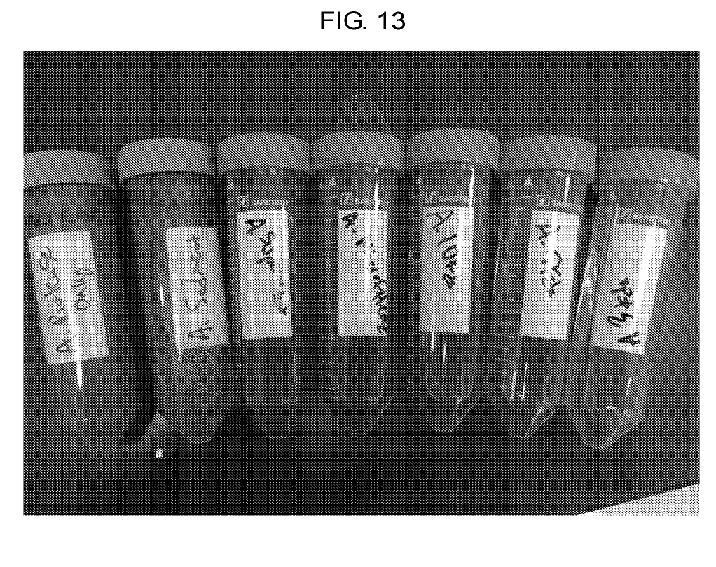

### DETAILED DESCRIPTION

The present disclosure is based, at least in part, on the discovery that the protein recovery process, as described herein, significantly increases the protein content and enhances the ability for the protein to be dispersed in liquid. As shown herein, Examples 1-3 resulted in insect products with improved characteristics (e.g., less non-soluble fiber, higher nutritional content, higher protein content, improved solubility, improved dispersion in liquid, more easily incorporated into food products) compared to insect products produced by conventional methods.

Insect Product

Insect products, as described herein, can comprise a composition derived from at least one insect. In some embodiments, the insect product can comprise solid insect matter particles.

Insect.

As described herein, an insect can be at least one whole insect, at least one whole adult insect, or at least one whole live insect. In some embodiments, the at least one insect can be a whole insect. A “whole insect” can be an insect of any life stage that is live, or euthanized, or preserved. In some embodiments, the whole insect can be a whole adult insect, in which the term “adult” can be defined as any life stage of an insect, including nymph. In some embodiments, the insect can be a non-adult insect (e.g., an egg, larva, or pupa).

In some embodiments, the insect can be a dewatered insect. In some embodiments, a dewatered insect can be dried or pre-dried. In some embodiments, the insect can be non-dewatered. For example, a “non-dewatered” insect can be “non-pre-dried” insect.

In some embodiments, the at least one insect can be washed or unwashed. In some embodiments, the whole insect can be a whole unwashed insect, in which the term “unwashed” can be defined as non-washed or non-cleansed.

In some embodiments, the insect can be pre-dried and pre-ground into a dried insect powder. For example, the dried insect powder can be a raw insect powder or dried insect flour.

In some embodiments, the dried insect powder can be diluted with a solution to create a slurry. For example, the solution can comprise water or water-based liquid. As another example, the solution can comprise a liquid other than water or a non-water based liquid. As another example, the solution can comprise alcohol, such as ethanol or an anhydrous liquid, such as oil.

In some embodiments, the optimum amount of dilution can be dependent on how much cricket flour can be successfully dissolved at a high concentration while allowing for the enzyme to diffuse through the mixture and access the substrates.

Insects can include arthropods or invertebrates. For example, the insect can be superworms (Zophobas morio); crickets; House Cricket (Acheta domesticus) and Banded Cricket (Gryllodes sigillatus); mealworms (Tenebrio molitor); Caribbean fruit fly (Anastrepha suspensa); black soldier fly (Hermetia illucens); grasshoppers; locusts; katydids; Differential grasshopper (Melanoplus differentialis); Migratory grasshopper (Melanoplus sanguinipes), Chapulines Grasshopper (Sphenarium purpurascens); Desert Locust (Schistocerca gregaria), Nsenene Katydid (Ruspolia baileyi); Silkworms; or caterpillars (Bombyx mori).

Particle Size of Solid Insect Matter Particles.

As used herein, “solid insect matter particles” can be solid particles of comminuted whole insects.

In some embodiments, substantially all of the solid insect matter particles in the initial grind (e.g., shearing) insect product, have a particle size between about 0.1 μm and about 2,000 μm.

For example, the solid insect matter particles can have a particle size or an average particle size of about 1 μm; about 2 μm; about 3 μm; about 4 μm; about 5 μm; about 6 μm; about 7 μm; about 8 μm; about 9 μm; about 10 μm; about 11 μm; about 12 μm; about 13 μm; about 14 μm; about 15 μm; about 16 μm; about 17 μm; about 18 μm; about 19 μm; about 20 μm; about 21 μm; about 22 μm; about 23 μm; about 24 μm; about 25 μm; about 26 μm; about 27 μm; about 28 μm; about 29 μm; about 30 μm; about 31 μm; about 32 μm; about 33 μm; about 34 μm; about 35 μm; about 36 μm; about 37 μm; about 38 μm; about 39 μm; about 40 μm; about 41 μm; about 42 μm; about 43 μm; about 44 μm; about 45 μm; about 46 μm; about 47 μm; about 48 μm; about 49 μm; about 50 μm; about 60 μm; about 70 μm; about 80 μm; about 90 μm; about 100 μm; about 110 μm; about 120 μm; about 130 μm; about 140 μm; about 150 μm; about 160 μm; about 170 μm; about 180 μm; about 190 μm; about 200 μm; about 210 μm; about 220 μm; about 230 μm; about 240 μm; about 250 μm; about 260 μm; about 270 μm; about 280 μm; about 290 μm; about 300 μm; about 310 μm; about 320 μm; about 330 μm; about 340 μm; about 350 μm; about 360 μm; about 370 μm; about 380 μm; about 390 μm; about 400 μm; about 410 μm; about 420 μm; about 430 μm; about 440 μm; about 450 μm; about 460 μm; about 470 μm; about 480 μm; about 490 μm; about 500 μm; about 510 μm; about 520 μm; about 530 μm; about 540 μm; about 550; about 560 μm; about 570 μm; about 580 μm; about 590 μm; about 600 μm; about 610 μm; about 620 μm; about 630 μm; about 640 μm; about 650; about 660 μm; about 670 μm; about 680 μm; about 690 μm; about 700 μm; about 710 μm; about 720 μm; about 730 μm; about 740 μm; about 750; about 760 μm; about 770 μm; about 780 μm; about 790 μm; about 800 μm; about 810 μm; about 820 μm; about 830 μm; about 840 μm; about 850; about 860 μm; about 870 μm; about 880 μm; about 890 μm; about 900 μm; about 910 μm; about 920 μm; about 930 μm; about 940 μm; about 950; about 960 μm; about 970 μm; about 980 μm; about 990 μm; or about 1000 μm. It is understood that recitation of the above range of values includes discrete values between each recited range. It is understood that recitation of the above discrete values includes a range between each recited value.

In another embodiment, between at least about 10% and at least about 90% of the solid insect matter particles, by volume, have a particle size of about 10 μm or less. For example, at least about 10%, at least about 20%, at least about 30%, at least about 40%, at least about 50%, at least about 60%, at least about 70%, at least about 80%, or at least about 90% of the solid insect matter particles, by volume, have a particle size of about 10 μm or less. It is understood that recitation of the above range of values includes discrete values between each recited range

In some embodiments, substantially all of the solid insect matter particles in the final insect product have a particle size of between about 0.01 μm and about 100 μm. For example, the solid insect matter particles can have a particle size or an average particle size of 0.01 μm; about 0.012 μm; about 0.014 μm; about 0.016 μm; about 0.018 μm; about 0.02 μm; about 0.025 μm; about 0.05 μm; about 0.075 μm; about 0.1 μm; about 0.2 μm; about 0.4 μm; about 0.6 μm; about 0.8 μm; about 1 μm; about 2 μm; about 3 μm; about 4 μm; about 5 μm; about 6 μm; about 7 μm; about 8 μm; about 9 μm; about 10 μm; about 11 μm; about 12 μm; about 13 μm; about 14 μm; about 15; about 16 μm; about 17 μm; about 18 μm; about 19 μm; about 20 μm; about 21 μm; about 22 μm; about 23 μm; about 24 μm; about 25 μm; about 26 μm; about 27 μm; about 28 μm; about 29 μm; about 30 μm; about 31 μm; about 32 μm; about 33 μm; about 34 μm; about 35 μm; about 36 μm; about 37 μm; about 38 μm; about 39 μm; about 40 μm; about 41 μm; about 42 μm; about 43 μm; about 44 μm; about 45 μm; about 46 μm; about 47 μm; about 48 μm; about 49 μm; about 50 μm; about 51 μm; about 52 μm; about 53 μm; about 54 μm; about 55 μm; about 56 μm; about 57 μm; about 58 μm; about 59 μm; about 60 μm; about 61 μm; about 62 μm; about 63 μm; about 64 μm; about 65 μm; about 66 μm; about 67 μm; about 68 μm; about 69 μm; about 70 μm; about 71 μm; about 72 μm; about 73 μm; about 74 μm; about 75 μm; about 76 μm; about 77 μm; about 78 μm; about 79 μm; about 80 μm; about 81 μm; about 82 μm; about 83 μm; about 84 μm; about 85 μm; about 86 μm; about 87 μm; about 88 μm; about 89 μm; about 90 μm; about 91 μm; about 92 μm; about 93 μm; about 94 μm; about 95 μm; about 96 μm; about 97 μm; about 98 μm; about 99 μm; or about 100 μm. It is understood that recitation of the above discrete values includes a range between each recited value. It is understood that recitation of the above ranges includes a discrete values between each recited range.

In some embodiments, the solid insect matter particles present in the insect product are in amount between about 85% and about 100% by weight of the insect product. In another embodiment, the solid insect matter particles present in the insect product are in amount from about 85% to about 95% by weight of the insect product. In yet another embodiment, the solid insect matter particles present in the insect product are in amount from about 85% to about 90% by weight of the insect product. In one embodiment, the solid insect matter particles present in the insect product are in amount from about 90% to about 100% by weight of the insect product. In another embodiment, the solid insect matter particles present in the insect product are in amount from about 95% to about 100% by weight of the insect product. In yet another embodiment, the solid insect matter particles present in the insect product are in amount from about 95% to about 99% by weight of the insect product. In another embodiment, the solid insect matter particles present in the insect product are in amount from about 95% to about 98% by weight of the insect product. In yet another embodiment, the solid insect matter particles present in the insect product are in amount from about 96% to about 98% by weight of the insect product. In a further embodiment, the solid insect matter particles present in the insect product are in amount from about 97% to about 100% by weight of the insect product. It is understood that recitation of the above range of values includes discrete values between each recited range.

As another example, the solid insect matter particles present in the insect product can be in an amount of about 1% by weight of the insect product, about 2% by weight of the insect product, about 3% by weight of the insect product, about 4% by weight of the insect product, about 5% by weight of the insect product, about 6% by weight of the insect product, about 7% by weight of the insect product, about 8% by weight of the insect product, about 9% by weight of the insect product, about 10% by weight of the insect product, 11% by weight of the insect product, about 12% by weight of the insect product, about 13% by weight of the insect product, about 14% by weight of the insect product, about 15% by weight of the insect product, about 16% by weight of the insect product, about 17% by weight of the insect product, about 18% by weight of the insect product, about 19% by weight of the insect product, about 20% by weight of the insect product, 21% by weight of the insect product, about 22% by weight of the insect product, about 23% by weight of the insect product, about 24% by weight of the insect product, about 25% by weight of the insect product, about 26% by weight of the insect product, about 27% by weight of the insect product, about 28% by weight of the insect product, about 29% by weight of the insect product, about 30% by weight of the insect product, 31% by weight of the insect product, about 32% by weight of the insect product, about 33% by weight of the insect product, about 34% by weight of the insect product, about 35% by weight of the insect product, about 36% by weight of the insect product, about 37% by weight of the insect product, about 38% by weight of the insect product, about 39% by weight of the insect product, about 40% by weight of the insect product, 41% by weight of the insect product, about 42% by weight of the insect product, about 43% by weight of the insect product, about 44% by weight of the insect product, about 45% by weight of the insect product, about 46% by weight of the insect product, about 47% by weight of the insect product, about 48% by weight of the insect product, about 49% by weight of the insect product, about 50% by weight of the insect product, 51% by weight of the insect product, about 52% by weight of the insect product, about 53% by weight of the insect product, about 54% by weight of the insect product, about 55% by weight of the insect product, about 56% by weight of the insect product, about 57% by weight of the insect product, about 58% by weight of the insect product, about 59% by weight of the insect product, about 60% by weight of the insect product, 61% by weight of the insect product, about 62% by weight of the insect product, about 63% by weight of the insect product, about 64% by weight of the insect product, about 65% by weight of the insect product, about 66% by weight of the insect product, about 67% by weight of the insect product, about 68% by weight of the insect product, about 69% by weight of the insect product, about 70% by weight of the insect product, 71% by weight of the insect product, about 72% by weight of the insect product, about 73% by weight of the insect product, about 74% by weight of the insect product, about 75% by weight of the insect product, about 76% by weight of the insect product, about 77% by weight of the insect product, about 78% by weight of the insect product, about 79% by weight of the insect product, about 80% by weight of the insect product, 81% by weight of the insect product, about 82% by weight of the insect product, about 83% by weight of the insect product, about 84% by weight of the insect product, about 85% by weight of the insect product, about 86% by weight of the insect product, about 87% by weight of the insect product, about 88% by weight of the insect product, about 89% by weight of the insect product, about 90% by weight of the insect product, 91% by weight of the insect product, about 92% by weight of the insect product, about 93% by weight of the insect product, about 94% by weight of the insect product, about 95% by weight of the insect product, about 96% by weight of the insect product, about 97% by weight of the insect product, about 98% by weight of the insect product, about 99% by weight of the insect product, or about 100% by weight of the insect product. It is understood that recitation of the above discrete values includes a range between each recited value. It is understood that recitation of the above ranges includes a discrete values between each recited range.

Composition.

As described herein an insect product and precursors to the insect product can include protein, fat, carbohydrate, ash, chitin, or fiber. The composition of these components can also affect the solubility.

(i) Protein.

In some embodiments, the insect product can comprise a protein in an amount of about 50% or more by weight based on dry weight of the insect product.

In other embodiments, the insect product can comprise a protein in an amount of about 25% or more by weight based on dry weight of the insect product. In other embodiments, the insect product can comprise a protein in an amount of between about 25% and about 99% by weight based on dry weight of the insect product. In other embodiments, the insect product can comprise a protein in an amount of between about 90% and about 99% by weight based on dry weight of the insect product. It is understood that recitation of the above range of values includes discrete values between each recited range. In determining protein content, the test method AOAC Official Method 992.15 and the test method AACC Official Method 46-30 can be used as a guideline.

For example, the protein present in the insect product can be in amount of 1% by dry weight of the insect product, about 2% by dry weight of the insect product, about 3% by dry weight of the insect product, about 4% by dry weight of the insect product, about 5% by dry weight of the insect product, about 6% by dry weight of the insect product, about 7% by dry weight of the insect product, about 8% by dry weight of the insect product, about 9% by dry weight of the insect product, about 10% by dry weight of the insect product, 11% by dry weight of the insect product, about 12% by dry weight of the insect product, about 13% by dry weight of the insect product, about 14% by dry weight of the insect product, about 15% by dry weight of the insect product, about 16% by dry weight of the insect product, about 17% by dry weight of the insect product, about 18% by dry weight of the insect product, about 19% by dry weight of the insect product, about 20% by dry weight of the insect product, 21% by dry weight of the insect product, about 22% by dry weight of the insect product, about 23% by dry weight of the insect product, about 24% by dry weight of the insect product, about 25% by dry weight of the insect product, about 26% by dry weight of the insect product, about 27% by dry weight of the insect product, about 28% by dry weight of the insect product, about 29% by dry weight of the insect product, about 30% by dry weight of the insect product, 31% by dry weight of the insect product, about 32% by dry weight of the insect product, about 33% by dry weight of the insect product, about 34% by dry weight of the insect product, about 35% by dry weight of the insect product, about 36% by dry weight of the insect product, about 37% by dry weight of the insect product, about 38% by dry weight of the insect product, about 39% by dry weight of the insect product, about 40% by dry weight of the insect product, 41% by dry weight of the insect product, about 42% by dry weight of the insect product, about 43% by dry weight of the insect product, about 44% by dry weight of the insect product, about 45% by dry weight of the insect product, about 46% by dry weight of the insect product, about 47% by dry weight of the insect product, about 48% by dry weight of the insect product, about 49% by dry weight of the insect product, about 50% by dry weight of the insect product, 51% by dry weight of the insect product, about 52% by dry weight of the insect product, about 53% by dry weight of the insect product, about 54% by dry weight of the insect product, about 55% by dry weight of the insect product, about 56% by dry weight of the insect product, about 57% by dry weight of the insect product, about 58% by dry weight of the insect product, about 59% by dry weight of the insect product, about 60% by dry weight of the insect product, 61% by dry weight of the insect product, about 62% by dry weight of the insect product, about 63% by dry weight of the insect product, about 64% by dry weight of the insect product, about 65% by dry weight of the insect product, about 66% by dry weight of the insect product, about 67% by dry weight of the insect product, about 68% by dry weight of the insect product, about 69% by dry weight of the insect product, about 70% by dry weight of the insect product, 71% by dry weight of the insect product, about 72% by dry weight of the insect product, about 73% by dry weight of the insect product, about 74% by dry weight of the insect product, about 75% by dry weight of the insect product, about 76% by dry weight of the insect product, about 77% by dry weight of the insect product, about 78% by dry weight of the insect product, about 79% by dry weight of the insect product, about 80% by dry weight of the insect product, 81% by dry weight of the insect product, about 82% by dry weight of the insect product, about 83% by dry weight of the insect product, about 84% by dry weight of the insect product, about 85% by dry weight of the insect product, about 86% by dry weight of the insect product, about 87% by dry weight of the insect product, about 88% by dry weight of the insect product, about 89% by dry weight of the insect product, about 90% by dry weight of the insect product, 91% by dry weight of the insect product, about 92% by dry weight of the insect product, about 93% by dry weight of the insect product, about 94% by dry weight of the insect product, about 95% by dry weight of the insect product, about 96% by dry weight of the insect product, about 97% by dry weight of the insect product, about 98% by dry weight of the insect product, about 99% by dry weight of the insect product, or about 100% by dry weight of the insect product. It is understood that recitation of the above discrete values includes a range between each recited value. It is understood that recitation of the above ranges includes a discrete values between each recited range.

(ii) Fat.

In some embodiments, the insect product can comprise fat in an amount of less than about 50% by weight based on the dry weight of the insect product.

In another embodiment, the insect product can comprise fat in an amount of less than about 20% by weight based on the dry weight of the insect product.

In another embodiment, the insect product can comprise fat in an amount between about 0% and about 20% by weight based on the dry weight of the insect product. For example, the insect product can comprise fat in an amount between about 0% and about 5% by weight based on the dry weight of the insect product. It is understood that recitation of the above range of values includes discrete values between each recited range. In determining fat content, the test method AOAC Official Method 996.06 can be used as a guideline.

For example, the fat present in the insect product can be in amount of 1% by dry weight of the insect product, about 2% by dry weight of the insect product, about 3% by dry weight of the insect product, about 4% by dry weight of the insect product, about 5% by dry weight of the insect product, about 6% by dry weight of the insect product, about 7% by dry weight of the insect product, about 8% by dry weight of the insect product, about 9% by dry weight of the insect product, about 10% by dry weight of the insect product, 11% by dry weight of the insect product, about 12% by dry weight of the insect product, about 13% by dry weight of the insect product, about 14% by dry weight of the insect product, about 15% by dry weight of the insect product, about 16% by dry weight of the insect product, about 17% by dry weight of the insect product, about 18% by dry weight of the insect product, about 19% by dry weight of the insect product, about 20% by dry weight of the insect product, 21% by dry weight of the insect product, about 22% by dry weight of the insect product, about 23% by dry weight of the insect product, about 24% by dry weight of the insect product, about 25% by dry weight of the insect product, about 26% by dry weight of the insect product, about 27% by dry weight of the insect product, about 28% by dry weight of the insect product, about 29% by dry weight of the insect product, about 30% by dry weight of the insect product, 31% by dry weight of the insect product, about 32% by dry weight of the insect product, about 33% by dry weight of the insect product, about 34% by dry weight of the insect product, about 35% by dry weight of the insect product, about 36% by dry weight of the insect product, about 37% by dry weight of the insect product, about 38% by dry weight of the insect product, about 39% by dry weight of the insect product, about 40% by dry weight of the insect product, 41% by dry weight of the insect product, about 42% by dry weight of the insect product, about 43% by dry weight of the insect product, about 44% by dry weight of the insect product, about 45% by dry weight of the insect product, about 46% by dry weight of the insect product, about 47% by dry weight of the insect product, about 48% by dry weight of the insect product, about 49% by dry weight of the insect product, about 50% by dry weight of the insect product, 51% by dry weight of the insect product, about 52% by dry weight of the insect product, about 53% by dry weight of the insect product, about 54% by dry weight of the insect product, about 55% by dry weight of the insect product, about 56% by dry weight of the insect product, about 57% by dry weight of the insect product, about 58% by dry weight of the insect product, about 59% by dry weight of the insect product, about 60% by dry weight of the insect product, 61% by dry weight of the insect product, about 62% by dry weight of the insect product, about 63% by dry weight of the insect product, about 64% by dry weight of the insect product, about 65% by dry weight of the insect product, about 66% by dry weight of the insect product, about 67% by dry weight of the insect product, about 68% by dry weight of the insect product, about 69% by dry weight of the insect product, about 70% by dry weight of the insect product, 71% by dry weight of the insect product, about 72% by dry weight of the insect product, about 73% by dry weight of the insect product, about 74% by dry weight of the insect product, about 75% by dry weight of the insect product, about 76% by dry weight of the insect product, about 77% by dry weight of the insect product, about 78% by dry weight of the insect product, about 79% by dry weight of the insect product, about 80% by dry weight of the insect product, 81% by dry weight of the insect product, about 82% by dry weight of the insect product, about 83% by dry weight of the insect product, about 84% by dry weight of the insect product, about 85% by dry weight of the insect product, about 86% by dry weight of the insect product, about 87% by dry weight of the insect product, about 88% by dry weight of the insect product, about 89% by dry weight of the insect product, about 90% by dry weight of the insect product, 91% by dry weight of the insect product, about 92% by dry weight of the insect product, about 93% by dry weight of the insect product, about 94% by dry weight of the insect product, about 95% by dry weight of the insect product, about 96% by dry weight of the insect product, about 97% by dry weight of the insect product, about 98% by dry weight of the insect product, about 99% by dry weight of the insect product, or about 100% by dry weight of the insect product. It is understood that recitation of the above discrete values includes a range between each recited value. It is understood that recitation of the above ranges includes a discrete values between each recited range.

(iii) Carbohydrate.

In some embodiments, the insect product can comprise carbohydrate in an amount of less than about 50% by weight based on the dry weight of the insect product.

In another embodiment, the insect product can comprise carbohydrate in an amount of less than about 20% by weight based on the dry weight of the insect product.

In another embodiment, the insect product can comprise carbohydrate in an amount between about 0% and about 20% by weight based on the dry weight of the insect product. For example, the insect product can comprise carbohydrate in an amount between about 0% and about 5% by weight based on the dry weight of the insect product. It is understood that recitation of the above range of values includes discrete values between each recited range.

For example, the carbohydrate present in the insect product can be in amount of 1% by dry weight of the insect product, about 2% by dry weight of the insect product, about 3% by dry weight of the insect product, about 4% by dry weight of the insect product, about 5% by dry weight of the insect product, about 6% by dry weight of the insect product, about 7% by dry weight of the insect product, about 8% by dry weight of the insect product, about 9% by dry weight of the insect product, about 10% by dry weight of the insect product, 11% by dry weight of the insect product, about 12% by dry weight of the insect product, about 13% by dry weight of the insect product, about 14% by dry weight of the insect product, about 15% by dry weight of the insect product, about 16% by dry weight of the insect product, about 17% by dry weight of the insect product, about 18% by dry weight of the insect product, about 19% by dry weight of the insect product, about 20% by dry weight of the insect product, 21% by dry weight of the insect product, about 22% by dry weight of the insect product, about 23% by dry weight of the insect product, about 24% by dry weight of the insect product, about 25% by dry weight of the insect product, about 26% by dry weight of the insect product, about 27% by dry weight of the insect product, about 28% by dry weight of the insect product, about 29% by dry weight of the insect product, about 30% by dry weight of the insect product, 31% by dry weight of the insect product, about 32% by dry weight of the insect product, about 33% by dry weight of the insect product, about 34% by dry weight of the insect product, about 35% by dry weight of the insect product, about 36% by dry weight of the insect product, about 37% by dry weight of the insect product, about 38% by dry weight of the insect product, about 39% by dry weight of the insect product, about 40% by dry weight of the insect product, 41% by dry weight of the insect product, about 42% by dry weight of the insect product, about 43% by dry weight of the insect product, about 44% by dry weight of the insect product, about 45% by dry weight of the insect product, about 46% by dry weight of the insect product, about 47% by dry weight of the insect product, about 48% by dry weight of the insect product, about 49% by dry weight of the insect product, about 50% by dry weight of the insect product, 51% by dry weight of the insect product, about 52% by dry weight of the insect product, about 53% by dry weight of the insect product, about 54% by dry weight of the insect product, about 55% by dry weight of the insect product, about 56% by dry weight of the insect product, about 57% by dry weight of the insect product, about 58% by dry weight of the insect product, about 59% by dry weight of the insect product, about 60% by dry weight of the insect product, 61% by dry weight of the insect product, about 62% by dry weight of the insect product, about 63% by dry weight of the insect product, about 64% by dry weight of the insect product, about 65% by dry weight of the insect product, about 66% by dry weight of the insect product, about 67% by dry weight of the insect product, about 68% by dry weight of the insect product, about 69% by dry weight of the insect product, about 70% by dry weight of the insect product, 71% by dry weight of the insect product, about 72% by dry weight of the insect product, about 73% by dry weight of the insect product, about 74% by dry weight of the insect product, about 75% by dry weight of the insect product, about 76% by dry weight of the insect product, about 77% by dry weight of the insect product, about 78% by dry weight of the insect product, about 79% by dry weight of the insect product, about 80% by dry weight of the insect product, 81% by dry weight of the insect product, about 82% by dry weight of the insect product, about 83% by dry weight of the insect product, about 84% by dry weight of the insect product, about 85% by dry weight of the insect product, about 86% by dry weight of the insect product, about 87% by dry weight of the insect product, about 88% by dry weight of the insect product, about 89% by dry weight of the insect product, about 90% by dry weight of the insect product, 91% by dry weight of the insect product, about 92% by dry weight of the insect product, about 93% by dry weight of the insect product, about 94% by dry weight of the insect product, about 95% by dry weight of the insect product, about 96% by dry weight of the insect product, about 97% by dry weight of the insect product, about 98% by dry weight of the insect product, about 99% by dry weight of the insect product, or about 100% by dry weight of the insect product. It is understood that recitation of the above discrete values includes a range between each recited value. It is understood that recitation of the above ranges includes a discrete values between each recited range.

(iv) Ash.

In some embodiments, the insect product can comprise ash in an amount of less than about 50% by weight based on the dry weight of the insect product. In another embodiment, the insect product can comprise ash in an amount of less than about 20% by weight based on the dry weight of the insect product. In another embodiment, the insect product can comprise ash in an amount between about 0% and about 20% by weight based on the dry weight of the insect product. For example, the insect product can comprise ash in an amount between about 0% and about 5% by weight based on the dry weight of the insect product. It is understood that recitation of the above range of values includes discrete values between each recited range.

For example, the ash present in the insect product can be in amount of 1% by dry weight of the insect product, about 2% by dry weight of the insect product, about 3% by dry weight of the insect product, about 4% by dry weight of the insect product, about 5% by dry weight of the insect product, about 6% by dry weight of the insect product, about 7% by dry weight of the insect product, about 8% by dry weight of the insect product, about 9% by dry weight of the insect product, about 10% by dry weight of the insect product, 11% by dry weight of the insect product, about 12% by dry weight of the insect product, about 13% by dry weight of the insect product, about 14% by dry weight of the insect product, about 15% by dry weight of the insect product, about 16% by dry weight of the insect product, about 17% by dry weight of the insect product, about 18% by dry weight of the insect product, about 19% by dry weight of the insect product, about 20% by dry weight of the insect product, 21% by dry weight of the insect product, about 22% by dry weight of the insect product, about 23% by dry weight of the insect product, about 24% by dry weight of the insect product, about 25% by dry weight of the insect product, about 26% by dry weight of the insect product, about 27% by dry weight of the insect product, about 28% by dry weight of the insect product, about 29% by dry weight of the insect product, about 30% by dry weight of the insect product, 31% by dry weight of the insect product, about 32% by dry weight of the insect product, about 33% by dry weight of the insect product, about 34% by dry weight of the insect product, about 35% by dry weight of the insect product, about 36% by dry weight of the insect product, about 37% by dry weight of the insect product, about 38% by dry weight of the insect product, about 39% by dry weight of the insect product, about 40% by dry weight of the insect product, 41% by dry weight of the insect product, about 42% by dry weight of the insect product, about 43% by dry weight of the insect product, about 44% by dry weight of the insect product, about 45% by dry weight of the insect product, about 46% by dry weight of the insect product, about 47% by dry weight of the insect product, about 48% by dry weight of the insect product, about 49% by dry weight of the insect product, about 50% by dry weight of the insect product, 51% by dry weight of the insect product, about 52% by dry weight of the insect product, about 53% by dry weight of the insect product, about 54% by dry weight of the insect product, about 55% by dry weight of the insect product, about 56% by dry weight of the insect product, about 57% by dry weight of the insect product, about 58% by dry weight of the insect product, about 59% by dry weight of the insect product, about 60% by dry weight of the insect product, 61% by dry weight of the insect product, about 62% by dry weight of the insect product, about 63% by dry weight of the insect product, about 64% by dry weight of the insect product, about 65% by dry weight of the insect product, about 66% by dry weight of the insect product, about 67% by dry weight of the insect product, about 68% by dry weight of the insect product, about 69% by dry weight of the insect product, about 70% by dry weight of the insect product, 71% by dry weight of the insect product, about 72% by dry weight of the insect product, about 73% by dry weight of the insect product, about 74% by dry weight of the insect product, about 75% by dry weight of the insect product, about 76% by dry weight of the insect product, about 77% by dry weight of the insect product, about 78% by dry weight of the insect product, about 79% by dry weight of the insect product, about 80% by dry weight of the insect product, 81% by dry weight of the insect product, about 82% by dry weight of the insect product, about 83% by dry weight of the insect product, about 84% by dry weight of the insect product, about 85% by dry weight of the insect product, about 86% by dry weight of the insect product, about 87% by dry weight of the insect product, about 88% by dry weight of the insect product, about 89% by dry weight of the insect product, about 90% by dry weight of the insect product, 91% by dry weight of the insect product, about 92% by dry weight of the insect product, about 93% by dry weight of the insect product, about 94% by dry weight of the insect product, about 95% by dry weight of the insect product, about 96% by dry weight of the insect product, about 97% by dry weight of the insect product, about 98% by dry weight of the insect product, about 99% by dry weight of the insect product, or about 100% by dry weight of the insect product. It is understood that recitation of the above discrete values includes a range between each recited value. It is understood that recitation of the above ranges includes a discrete values between each recited range.

(v) Chitin.

In some embodiments, the insect product can comprise a reduced amount of chitin compared with the insect starting material. In one embodiment, the insect product can comprise chitin in an amount of less than about 20% by weight based on the dry weight of the insect product. In another embodiment, the insect material can comprise chitin in an amount of less than about 10% by weight based on the dry weight of the insect product. In yet another embodiment, the insect material can comprise chitin in an amount from about 0.01% to about 20% by weight based on the dry weight of the insect material. It is understood that recitation of the above range of values includes discrete values between each recited range.

Chitin can be considered a component of the exoskeleton portion of insects. Chitin can be non-readily dissolvable in water, aqueous solvents, or other solvents. Removing chitin is useful for insect products where low fiber is desirable. Low fiber can be desirable for improving texture, flavor, color, or processing efficiency. Fiber can be reduced for dietary or nutritional purposes. Chitin by itself can have multiple applications in food, agriculture, medicine, or materials.

For example, the chitin present in the insect product can be in amount of 1% by dry weight of the insect product, about 2% by dry weight of the insect product, about 3% by dry weight of the insect product, about 4% by dry weight of the insect product, about 5% by dry weight of the insect product, about 6% by dry weight of the insect product, about 7% by dry weight of the insect product, about 8% by dry weight of the insect product, about 9% by dry weight of the insect product, about 10% by dry weight of the insect product, 11% by dry weight of the insect product, about 12% by dry weight of the insect product, about 13% by dry weight of the insect product, about 14% by dry weight of the insect product, about 15% by dry weight of the insect product, about 16% by dry weight of the insect product, about 17% by dry weight of the insect product, about 18% by dry weight of the insect product, about 19% by dry weight of the insect product, about 20% by dry weight of the insect product, 21% by dry weight of the insect product, about 22% by dry weight of the insect product, about 23% by dry weight of the insect product, about 24% by dry weight of the insect product, about 25% by dry weight of the insect product, about 26% by dry weight of the insect product, about 27% by dry weight of the insect product, about 28% by dry weight of the insect product, about 29% by dry weight of the insect product, about 30% by dry weight of the insect product, 31% by dry weight of the insect product, about 32% by dry weight of the insect product, about 33% by dry weight of the insect product, about 34% by dry weight of the insect product, about 35% by dry weight of the insect product, about 36% by dry weight of the insect product, about 37% by dry weight of the insect product, about 38% by dry weight of the insect product, about 39% by dry weight of the insect product, about 40% by dry weight of the insect product, 41% by dry weight of the insect product, about 42% by dry weight of the insect product, about 43% by dry weight of the insect product, about 44% by dry weight of the insect product, about 45% by dry weight of the insect product, about 46% by dry weight of the insect product, about 47% by dry weight of the insect product, about 48% by dry weight of the insect product, about 49% by dry weight of the insect product, about 50% by dry weight of the insect product, 51% by dry weight of the insect product, about 52% by dry weight of the insect product, about 53% by dry weight of the insect product, about 54% by dry weight of the insect product, about 55% by dry weight of the insect product, about 56% by dry weight of the insect product, about 57% by dry weight of the insect product, about 58% by dry weight of the insect product, about 59% by dry weight of the insect product, about 60% by dry weight of the insect product, 61% by dry weight of the insect product, about 62% by dry weight of the insect product, about 63% by dry weight of the insect product, about 64% by dry weight of the insect product, about 65% by dry weight of the insect product, about 66% by dry weight of the insect product, about 67% by dry weight of the insect product, about 68% by dry weight of the insect product, about 69% by dry weight of the insect product, about 70% by dry weight of the insect product, 71% by dry weight of the insect product, about 72% by dry weight of the insect product, about 73% by dry weight of the insect product, about 74% by dry weight of the insect product, about 75% by dry weight of the insect product, about 76% by dry weight of the insect product, about 77% by dry weight of the insect product, about 78% by dry weight of the insect product, about 79% by dry weight of the insect product, about 80% by dry weight of the insect product, 81% by dry weight of the insect product, about 82% by dry weight of the insect product, about 83% by dry weight of the insect product, about 84% by dry weight of the insect product, about 85% by dry weight of the insect product, about 86% by dry weight of the insect product, about 87% by dry weight of the insect product, about 88% by dry weight of the insect product, about 89% by dry weight of the insect product, about 90% by dry weight of the insect product, 91% by dry weight of the insect product, about 92% by dry weight of the insect product, about 93% by dry weight of the insect product, about 94% by dry weight of the insect product, about 95% by dry weight of the insect product, about 96% by dry weight of the insect product, about 97% by dry weight of the insect product, about 98% by dry weight of the insect product, about 99% by dry weight of the insect product, or about 100% by dry weight of the insect product. It is understood that recitation of the above discrete values includes a range between each recited value. It is understood that recitation of the above ranges includes a discrete values between each recited range.

(vi) Fiber.

As described herein, the insect product can comprise fiber. In some embodiments, the insect material can comprise dietary fiber in an amount of less than about 10% by weight based on the dry weight of the insect material. In one embodiment, the insect material can comprise dietary fiber in an amount of less than about 5% by weight based on the dry weight of the insect material. In another embodiment, the insect material can comprise dietary fiber in an amount from about 0.01% to about 10% by weight based on the dry weight of the insect material. In yet another embodiment, the insect material can comprise dietary fiber in an amount from about 0.01% to about 5% by weight based on the dry weight of the insect material.

For example, the insect material can comprise dietary fiber in an amount of 1% by dry weight, about 2% by dry weight, about 3% by dry weight, about 4% by dry weight, about 5% by dry weight, about 6% by dry weight, about 7% by dry weight, about 8% by dry weight, about 9% by dry weight, about 10% by dry weight, 11% by dry weight, about 12% by dry weight, about 13% by dry weight, about 14% by dry weight, about 15% by dry weight, about 16% by dry weight, about 17% by dry weight, about 18% by dry weight, about 19% by dry weight, about 20% by dry weight, 21% by dry weight, about 22% by dry weight, about 23% by dry weight, about 24% by dry weight, about 25% by dry weight, about 26% by dry weight, about 27% by dry weight, about 28% by dry weight, about 29% by dry weight, about 30% by dry weight, 31% by dry weight, about 32% by dry weight, about 33% by dry weight, about 34% by dry weight, about 35% by dry weight, about 36% by dry weight, about 37% by dry weight, about 38% by dry weight, about 39% by dry weight, about 40% by dry weight, 41% by dry weight, about 42% by dry weight, about 43% by dry weight, about 44% by dry weight, about 45% by dry weight, about 46% by dry weight, about 47% by dry weight, about 48% by dry weight, about 49% by dry weight, about 50% by dry weight, 51% by dry weight, about 52% by dry weight, about 53% by dry weight, about 54% by dry weight, about 55% by dry weight, about 56% by dry weight, about 57% by dry weight, about 58% by dry weight, about 59% by dry weight, about 60% by dry weight, 61% by dry weight, about 62% by dry weight, about 63% by dry weight, about 64% by dry weight, about 65% by dry weight, about 66% by dry weight, about 67% by dry weight, about 68% by dry weight, about 69% by dry weight, about 70% by dry weight, 71% by dry weight, about 72% by dry weight, about 73% by dry weight, about 74% by dry weight, about 75% by dry weight, about 76% by dry weight, about 77% by dry weight, about 78% by dry weight, about 79% by dry weight, about 80% by dry weight, 81% by dry weight, about 82% by dry weight, about 83% by dry weight, about 84% by dry weight, about 85% by dry weight, about 86% by dry weight, about 87% by dry weight, about 88% by dry weight, about 89% by dry weight, about 90% by dry weight, 91% by dry weight, about 92% by dry weight, about 93% by dry weight, about 94% by dry weight, about 95% by dry weight, about 96% by dry weight, about 97% by dry weight, about 98% by dry weight, about 99% by dry weight, or about 100% by dry weight. It is understood that recitation of the above range of values includes discrete values between each recited range.

(vii) Solubility.

As described herein, the insect product can be soluble. Although the solubility of heterogeneous protein mixtures can be difficult to accurately define, the solubility range can be between about 20% and 99% solubility. It is understood that recitation of the above range of values includes discrete values between each recited range.

For example, the solubility of the insect product can be about 1% solubility, about 2% solubility, about 3% solubility, about 4% solubility, about 5% solubility, about 6% solubility, about 7% solubility, about 8% solubility, about 9% solubility, about 10% solubility, 11% solubility, about 12% solubility, about 13% solubility, about 14% solubility, about 15% solubility, about 16% solubility, about 17% solubility, about 18% solubility, about 19% solubility, about 20% solubility, 21% solubility, about 22% solubility, about 23% solubility, about 24% solubility, about 25% solubility, about 26% solubility, about 27% solubility, about 28% solubility, about 29% solubility, about 30% solubility, 31% solubility, about 32% solubility, about 33% solubility, about 34% solubility, about 35% solubility, about 36% solubility, about 37% solubility, about 38% solubility, about 39% solubility, about 40% solubility, 41% solubility, about 42% solubility, about 43% solubility, about 44% solubility, about 45% solubility, about 46% solubility, about 47% solubility, about 48% solubility, about 49% solubility, about 50% solubility, 51% solubility, about 52% solubility, about 53% solubility, about 54% solubility, about 55% solubility, about 56% solubility, about 57% solubility, about 58% solubility, about 59% solubility, about 60% solubility, 61% solubility, about 62% solubility, about 63% solubility, about 64% solubility, about 65% solubility, about 66% solubility, about 67% solubility, about 68% solubility, about 69% solubility, about 70% solubility, 71% solubility, about 72% solubility, about 73% solubility, about 74% solubility, about 75% solubility, about 76% solubility, about 77% solubility, about 78% solubility, about 79% solubility, about 80% solubility, 81% solubility, about 82% solubility, about 83% solubility, about 84% solubility, about 85% solubility, about 86% solubility, about 87% solubility, about 88% solubility, about 89% solubility, about 90% solubility, 91% solubility, about 92% solubility, about 93% solubility, about 94% solubility, about 95% solubility, about 96% solubility, about 97% solubility, about 98% solubility, about 99% solubility, or about 100% solubility. It is understood that recitation of the above discrete values includes a range between each recited value. It is understood that recitation of the above ranges includes a discrete values between each recited range.

Auxiliary Components.

The compositions and methods, as described herein, can include auxiliary components to enhance characteristics of the final product or intermediate products. For example, auxiliary components can include flavor enhancing or solubility enhancing components.

Any flavorant suitable for use for human or animal consumption can be used. For example, flavorants can be one or more of the following: spices, herbs, or other natural ground flavorings (e.g., cocoa, vanilla, cinnamon, natural flavor extracts, etc.) for use as an aroma or off flavor masking; hydrocolloid gums (e.g., xanthan, guar, gum acacia) to, for example, increase ease of suspension of particulate, improved/more/enhanced viscous mouthfeel, or improved dispersion of particulate; stevia, sucralose, sugar alcohol, monkfruit extract to, for example, for sweeten; salt to for example, increase sweetness perception; lecithin, mono/diglycerides, or other lipid emulsifiers to, for example, preserve an emulsion in, for example, food and beverage applications.

Commercial Products.

The insect products as described herein can be used in a wide variety of products, including but not limited to: food products (e.g., meat alternatives), meat filler, protein bars, snack foods, pastas, protein powder (e.g., for shakes or beverages), candies, ice cream, cheese, dairy substitutes, breads and baked goods; Ready to Use Therapeutic Food (“RUTF”), Ready to Use Supplementary Food (“RUSF”), animal feed and pellets, nutraceutical ingredients (e.g., omega fatty acids, vitamins, minerals, enzymes), or pharmaceuticals (e.g., antibiotics). In one embodiment, the insect product can be mixed with flavors, coloring, seasonings, oil, fat, spices, nutrients, or vitamin supplements.

Shelf Life.

As described herein, the insect product can be shelf-stable. In some embodiments, the insect products as described herein can have a shelf life of up to about 4 years. In some embodiments, the insect products as described herein can have a shelf life between about 12 months and about 24 months.

Packaging.

Dried insect product (e.g., powder) can be packaged in airtight containers or soft or rigid-walled containers.

Manufacture

A method for making an insect product described herein can comprise grinding at least one insect into an insect paste. The insect paste can be diluted with a liquid (e.g., water) to form a slurry. A composition comprising an enzyme (e.g., protease) can be added to the slurry. The slurry comprising the enzyme can be filtered through a microfilter. The permeate from the microfiltration can be filtered by any process known in the art such as ultrafiltration, nanofiltration, or reverse osmosis. The retentate from the filtration (e.g., ultrafiltration nanofiltration, or reverse osmosis) can be dried or substantially dried to form an insect product.

Insect Processing.

As described herein, an insect can be processed. In some embodiments, the insect can be processed by grinding or shearing. For example, an insect can be processed using wet grinding. Processing an insect as described herein, can result in an insect paste or insect powder.

The term grinding, as used herein, can comprise a grinding process of at least one dewatered or non-dewatered insect with or without added liquid (e.g., water). In one embodiment, grinding can include one grinding step that grinds the at least one whole insect to desired particle sizes (e.g., particles sizes of about 200 μm or less).

The term wet-grinding, as used herein, can be defined as a grinding process of at least one non-dewatered insect with or without added liquid (e.g., water). In one embodiment, wet-grinding can include one grinding step that grinds the at least one whole insect to desired particle sizes (e.g., particles sizes of about 200 μm or less).

In other embodiments, grinding or wet-grinding can include two separate grinding steps: a coarse grinding or wet-grinding and a fine grinding or wet-grinding. A coarse grinding or wet-grinding process grinds the at least one whole insect to particle sizes of about 5 mm or less (e.g., particles sizes from about 1 mm to about 5 mm). A fine grinding or wet-grinding process grinds the at least one whole insect to particle sizes of about 200 μm or less (e.g., particles sizes from about 1 μm to about 200 μm). In some embodiments, a fine grinding or wet-grinding process may grind the at least one whole insect to particle sizes from about 1 μm to about 100 μm, from about 1 μm to 50 μm, or from about 1 μm to 10 μm. It is understood that recitation of the above range of values includes discrete values between each recited range.

The advantages of wet-stage grinding can include, for example: (1) reducing heat needed to preserve and dry the insect slurry; (2) minimizing/avoiding the negative effects heat has on the insect product properties; (3) increasing process efficiency; (4) improving product digestibility; and (5) improving process throughputs.

The grinding or wet-grinding process can be performed using at least one of, but not limited to, the following devices: grinders, mills, stone mills, mixers, peanut grinders, peanut butter grinders, disk mill (e.g., a stainless steel disk mill), colloid mills, pin mills, bead mills, dispersers, homogenizers, choppers, rotor stator devices, hammer mills, press grinders, mashers, macerators, food processors, rollers, or juicers. In one embodiment, the grinder is selected from at least one of the following: an Olde Tyme Peanut Mill, Olde Tyme Peanut Grinder, Olde Tyme Peanut butter Grinder, Olde Tyme Peanut butter Mill, Old Style Peanut Mill, Olde Style Peanut Grinder, Olde Style Peanut butter Grinder, Olde Style Peanut butter Mill, IKA mixer, or IKA colloid mill. In another embodiment, the juicer is a Jack LaLanne Power Juicer or an Acme 6001 Centrifugal Juicer.

Slurry.

As described herein, “insect slurry” is a semiliquid mixture of ground insects with added liquid. In one embodiment, the insect slurry can include a pre-determined ratio of insects (mass or volume) to added liquid (mass or volume) (e.g., water). For example, an insect slurry can include about a 1:10 weight ratio of insects to water (e.g., 1 kg of insects and 10 kg of water). In another embodiment, an insect slurry can include about a 1:1 weight ratio of insects to water. In yet another embodiment, an insect slurry can include a range of 1:10 to 10:1 weight ratio of insects to water. It is understood that recitation of the above range of values includes discrete values between each recited range.

In some embodiments, the dried insect powder or insect paste can be diluted with water between about a 1:1 dilution and about a 1:30 dilution (cricket:water by mass). For example, the cricket to water ratio can be about 1:1, about 1:2, about 1:3, about 1:4, about 1:5, about 1:6, about 1:7, about 1:8, about 1:9, about 1:10, about 1:11, about 1:12, about 1:13, about 1:14, about 1:15, about 1:16, about 1:17, about 1:18, about 1:19, about 1:20, about 1:21, about 1:22, about 1:23, about 1:24, about 1:25, about 1:26, about 1:27, about 1:28, about 1:29, or about 1:30. It is understood that recitation of the above discrete values includes a range between each recited value. It is understood that recitation of the above ranges includes a discrete values between each recited range.

As another example, the insect slurry can comprise insects at about 1% by weight, about 2% by weight, about 3% by weight, about 4% by weight, about 5% by weight, about 6% by weight, about 7% by weight, about 8% by weight, about 9% by weight, about 10% by weight, 11% by weight, about 12% by weight, about 13% by weight, about 14% by weight, about 15% by weight, about 16% by weight, about 17% by weight, about 18% by weight, about 19% by weight, about 20% by weight, 21% by weight, about 22% by weight, about 23% by weight, about 24% by weight, about 25% by weight, about 26% by weight, about 27% by weight, about 28% by weight, about 29% by weight, about 30% by weight, 31% by weight, about 32% by weight, about 33% by weight, about 34% by weight, about 35% by weight, about 36% by weight, about 37% by weight, about 38% by weight, about 39% by weight, about 40% by weight, 41% by weight, about 42% by weight, about 43% by weight, about 44% by weight, about 45% by weight, about 46% by weight, about 47% by weight, about 48% by weight, about 49% by weight, about 50% by weight, 51% by weight, about 52% by weight, about 53% by weight, about 54% by weight, about 55% by weight, about 56% by weight, about 57% by weight, about 58% by weight, about 59% by weight, about 60% by weight, 61% by weight, about 62% by weight, about 63% by weight, about 64% by weight, about 65% by weight, about 66% by weight, about 67% by weight, about 68% by weight, about 69% by weight, about 70% by weight, 71% by weight, about 72% by weight, about 73% by weight, about 74% by weight, about 75% by weight, about 76% by weight, about 77% by weight, about 78% by weight, about 79% by weight, about 80% by weight, 81% by weight, about 82% by weight, about 83% by weight, about 84% by weight, about 85% by weight, about 86% by weight, about 87% by weight, about 88% by weight, about 89% by weight, about 90% by weight, 91% by weight, about 92% by weight, about 93% by weight, about 94% by weight, about 95% by weight, about 96% by weight, about 97% by weight, about 98% by weight, about 99% by weight, or about 100% by weight. It is understood that recitation of the above discrete values includes a range between each recited value. It is understood that recitation of the above ranges includes a discrete values between each recited range.

Enzyme.

As described herein, an enzyme can be added to an insect slurry. The use of enzymes are well known in the art. Except as otherwise noted herein, therefore, the process of the present disclosure can be carried out in accordance with such processes.

Methods, as described herein, can comprise an enzyme. In some embodiments an enzyme can comprise one or more of a bromelain, papain, peptidase, or protease. For example, an enzyme can be selected from Bromelain (Ananas comorus stem); Papain (Carica papaya); Peptidase (Aspergillus oryzae); Peptidase (Aspergillus melleus); Protease (Aspergillus niger); Protease (Bacillus licheniformis); Protease (Bacillus subtilis); or Protease (Aspergillus oryzae). Compositions and methods as described herein can include a protease, peptidase, or a protease/peptidase cocktail.

A protease can come from a variety of sources such as animal (e.g., chymosin, trypsin, pepsin), plant (e.g., bromelain, papain, ficin), bacteria (e.g., subtilisin, bacillopeptidases), and fungi (e.g., Aspergillopepsin).

A protease can also be a serine protease, a threonine protease, a cysteine protease, an aspartic protease, a metalloprotease, or a glutamic acid protease.

A protease can be an endopeptidase, an exopeptidase (e.g., a carboxypeptidases, an aminopeptidases), or an AA-specific protease.

A protease (which can also be called a peptidase or proteinase) can be any enzyme that performs proteolysis, that is, begins protein catabolism by hydrolysis of the peptide bonds that link amino acids together in a polypeptide chain. Proteases have evolved multiple times, and different classes of protease can perform the same reaction by completely different catalytic mechanisms. Proteases, as described herein, can be found in, derived from, or isolated from animals, plants, fungi, bacteria, archaea, or viruses.

Proteases, as described herein can be a serine protease (i.e., using a serine alcohol), cysteine protease (i.e., using a cysteine thiol), threonine protease (i.e., using a threonine secondary alcohol), aspartic protease (i.e., using an aspartate carboxylic acid), glutamic protease (i.e., using a glutamate carboxylic acid), metalloprotease (i.e., using a metal, usually zinc), or asparagine peptide lyases (i.e., using an asparagine to perform an elimination reaction (not requiring water)). As another example, proteases can be acid proteases, neutral proteases, or basic proteases.

A protease, as described herein can be any protease known in the art sufficient for protein digestion. For example, the protease can be a fungal protease, for example, from Aspergillus oryzae.

A protease, as described herein can be of any sufficient strength suitable for digestion. For example, the protease can be at a strength or activity of about 500,000 HUT/g to about 800,000 HUT/g. As another example, the protease can be at a strength of about 10,000 HUT/g, about 50,000 HUT/g, about 100,000 HUT/g, about 150,000 HUT/g, about 200,000 HUT/g, about 250,000 HUT/g, about 300,000 HUT/g, about 350,000 HUT/g, about 400,000 HUT/g, about 450,000 HUT/g, about 500,000 HUT/g, about 550,000 HUT/g, about 600,000 HUT/g, about 650,000 HUT/g, about 700,000 HUT/g, about 750,000 HUT/g, about 800,000 HUT/g, about 850,000 HUT/g, about 900,000 HUT/g, about 950,000 HUT/g, or about 1,000,000 HUT/g. It is understood that recitation of the above discrete values includes a range between each recited value. It is understood that recitation of the above ranges includes a discrete values between each recited range.

A protease, as described herein, can be any protease known in the art suitable for digestion. For example, neutral proteases can be used, but it can also be feasible, however, to use an acid or alkaline-stable protease by first adjusting the pH of the slurry, adding the enzyme, digesting, and then adjusting the pH back to a palatable range for human consumption. As another example, the protease can be protease A or Flavorpro.

A protease can be from the same or different source as the peptidase. As another example, the peptidase and protease can be from the same or different fungal or bacterial source.

A peptidase, as described herein can be any peptidase known in the art sufficient for protein digestion. For example, the peptidase can be a fungal peptidase, for example, from Aspergillus oryzae.

A peptidase can be from the same or different source as the protease. As another example, the peptidase and protease can be from the same or different fungal or bacterial source.

As another example, the peptidase can be of any strength or activity sufficient for protein digestion. For example, the peptidase can be at a strength or activity of about 500 LAPU/g. As another example, the peptidase can be at a strength or activity of about 10 LAPU/g, about 20 LAPU/g, about 30 LAPU/g, about 40 LAPU/g, about 50 LAPU/g, about 60 LAPU/g, about 70 LAPU/g, about 80 LAPU/g, 90 LAPU/g, about 100 LAPU/g, about 110 LAPU/g, about 120 LAPU/g, about 130 LAPU/g, about 140 LAPU/g, about 150 LAPU/g, about 160 LAPU/g, about 170 LAPU/g, about 180 LAPU/g, about 190 LAPU/g, about 200 LAPU/g, about 210 LAPU/g, about 220 LAPU/g, about 230 LAPU/g, about 240 LAPU/g, about 250 LAPU/g, about 260 LAPU/g, about 270 LAPU/g, about 280 LAPU/g, about 290 LAPU/g, about 300 LAPU/g, about 410 LAPU/g, about 420 LAPU/g, about 430 LAPU/g, about 440 LAPU/g, about 450 LAPU/g, about 460 LAPU/g, about 470 LAPU/g, about 480 LAPU/g, about 490 LAPU/g, about 500 LAPU/g, about 510 LAPU/g, about 520 LAPU/g, about 530 LAPU/g, about 540 LAPU/g, about 550 LAPU/g, about 560 LAPU/g, about 570 LAPU/g, about 580 LAPU/g, about 590 LAPU/g, about 600 LAPU/g, about 610 LAPU/g, about 620 LAPU/g, about 630 LAPU/g, about 640 LAPU/g, about 650 LAPU/g, about 660 LAPU/g, about 670 LAPU/g, about 680 LAPU/g, about 690 LAPU/g, about 700 LAPU/g, about 710 LAPU/g, about 720 LAPU/g, about 730 LAPU/g, about 740 LAPU/g, about 750 LAPU/g, about 760 LAPU/g, about 770 LAPU/g, about 780 LAPU/g, about 790 LAPU/g, about 800 LAPU/g, about 810 LAPU/g, about 820 LAPU/g, about 830 LAPU/g, about 840 LAPU/g, about 850 LAPU/g, about 860 LAPU/g, about 870 LAPU/g, about 880 LAPU/g, about 890 LAPU/g, about 900 LAPU/g, about 910 LAPU/g, about 920 LAPU/g, about 930 LAPU/g, about 940 LAPU/g, about 950 LAPU/g, about 960 LAPU/g, about 970 LAPU/g, about 980 LAPU/g, about 990 LAPU/g, or about 1,000 LAPU/g. It is understood that recitation of the above discrete values includes a range between each recited value. It is understood that recitation of the above ranges includes a discrete values between each recited range.

An enzyme, protease, peptidase, or protease/peptidase cocktail, as described herein, can be of any concentration sufficient to digest the protein component of the slurry. For example, the enzyme, protease or peptidase or protease/peptidase cocktail can be dosed in the slurry at about 1% (w/w). As another example, the enzyme, protease or peptidase, or protease/peptidase cocktail can be dosed in the slurry at about 0.1% (w/w), about 0.2% (w/w), about 0.3% (w/w), about 0.4% (w/w), about 0.5% (w/w), about 0.6% (w/w), about 0.7% (w/w), about 0.8% (w/w), about 0.9% (w/w), about 1.0% (w/w), about 1.1% (w/w), about 1.2% (w/w), about 1.3% (w/w), about 1.4% (w/w), about 1.5% (w/w), about 1.6% (w/w), about 1.7% (w/w), about 1.8% (w/w), about 1.9% (w/w), about 2.0% (w/w), about 2.1% (w/w), about 2.2% (w/w), about 2.3% (w/w), about 2.4% (w/w), about 2.5% (w/w), about 2.6% (w/w), about 2.7% (w/w), about 2.8% (w/w), about 2.9% (w/w), about 3.0% (w/w), about 3.1% (w/w), about 3.2% (w/w), about 3.3% (w/w), about 3.4% (w/w), about 3.5% (w/w), about 3.6% (w/w), about 3.7% (w/w), about 3.8% (w/w), about 3.9% (w/w), about 4.0% (w/w), about 4.1% (w/w), about 4.2% (w/w), about 4.3% (w/w), about 4.4% (w/w), about 4.5% (w/w), about 4.6% (w/w), about 4.7% (w/w), about 4.8% (w/w), about 4.9% (w/w), about 5.0% (w/w), about 5.1% (w/w), about 5.2% (w/w), about 5.3% (w/w), about 5.4% (w/w), about 5.5% (w/w), about 5.6% (w/w), about 5.7% (w/w), about 5.8% (w/w), about 5.9% (w/w), about 6.0% (w/w), about 6.1% (w/w), about 6.2% (w/w), about 6.3% (w/w), about 6.4% (w/w), about 6.5% (w/w), about 6.6% (w/w), about 6.7% (w/w), about 6.8% (w/w), about 6.9% (w/w), about 7.0% (w/w), about 7.1% (w/w), about 7.2% (w/w), about 7.3% (w/w), about 7.4% (w/w), about 7.5% (w/w), about 7.6% (w/w), about 7.7% (w/w), about 7.8% (w/w), about 7.9% (w/w), about 8.0% (w/w), about 8.1% (w/w), about 8.2% (w/w), about 8.3% (w/w), about 8.4% (w/w), about 8.5% (w/w), about 8.6% (w/w), about 8.7% (w/w), about 8.8% (w/w), about 8.9% (w/w), about 9.0% (w/w), about 9.1% (w/w), about 9.2% (w/w), about 9.3% (w/w), about 9.4% (w/w), about 9.5% (w/w), about 9.6% (w/w), about 9.7% (w/w), about 9.8% (w/w), about 9.9% (w/w), or about 10.0% (w/w). It is understood that recitation of the above discrete values includes a range between each recited value. It is understood that recitation of the above ranges includes a discrete values between each recited range.

The protease or peptidase enzyme can be added to the slurry in an amount sufficient to digest protein. For example, the protease or peptidase enzyme can be added to the slurry in an amount of about 0.1 g, about 0.15 g, about 0.2 g, about 0.25 g, about 0.3 g, about 0.35 g, about 0.4 g, about 0.45 g, about 0.5 g, about 0.55 g, about 0.6 g, about 0.65 g, about 0.7 g, about 0.75 g, about 0.8 g, about 0.85 g, about 0.9 g, about 0.95 g, about 1.0 g, 1.1 g, about 1.2 g, about 1.3 g, about 1.4 g, about 1.5 g, about 1.6 g, about 1.7 g, about 1.8 g, about 1.9 g, about 2.0 g, 2.1 g, about 2.2 g, about 2.3 g, about 2.4 g, about 2.5 g, about 2.6 g, about 2.7 g, about 2.8 g, about 2.9 g, about 3.0 g, 3.1 g, about 3.2 g, about 3.3 g, about 3.4 g, about 3.5 g, about 3.6 g, about 3.7 g, about 3.8 g, about 3.9 g, about 4.0 g, 4.1 g, about 4.2 g, about 4.3 g, about 4.4 g, about 4.5 g, about 4.6 g, about 4.7 g, about 4.8 g, about 4.9 g, about 5.0 g, 5.1 g, about 5.2 g, about 5.3 g, about 5.4 g, about 5.5 g, about 5.6 g, about 5.7 g, about 5.8 g, about 5.9 g, about 6.0 g, 6.1 g, about 6.2 g, about 6.3 g, about 6.4 g, about 6.5 g, about 6.6 g, about 6.7 g, about 6.8 g, about 6.9 g, about 7.0 g, 7.1 g, about 7.2 g, about 7.3 g, about 7.4 g, about 7.5 g, about 7.6 g, about 7.7 g, about 7.8 g, about 7.9 g, about 8.0 g, 8.1 g, about 8.2 g, about 8.3 g, about 8.4 g, about 8.5 g, about 8.6 g, about 8.7 g, about 8.8 g, about 8.9 g, about 9.0 g, 9.1 g, about 9.2 g, about 9.3 g, about 9.4 g, about 9.5 g, about 9.6 g, about 9.7 g, about 9.8 g, about 9.9 g, or about 10.0 g. It is understood that recitation of the above discrete values includes a range between each recited value. It is understood that recitation of the above ranges includes a discrete values between each recited range.

The function of the proteases and peptidases as described herein can improve the properties of food proteins, such as improved digestibility, or improved solubility, modified functional properties can include emulsification, fat-binding, water-binding, foaming properties, gel strength, or whipping properties, improved flavor and palatability, improved processing, such as viscosity reduction or improved drying.

pH.

As described herein, the pH of the slurry can be about 2 to 8. For example, the slurry can have a pH of about 2.0, about 2.1, about 2.2, about 2.3, about 2.4, about 2.5, about 2.6, about 2.7, about 2.8, about 2.9, about 3.0, about 3.1, about 3.2, about 3.3, about 3.4, about 3.5, about 3.6, about 3.7, about 3.8, about 3.9% (w/w), about 4.0, about 4.1, about 4.2, about 4.3, about 4.4, about 4.5, about 4.6, about 4.7, about 4.8, about 4.9, about 5.0, about 5.1, about 5.2, about 5.3, about 5.4, about 5.5, about 5.6, about 5.7, about 5.8, about 5.9, about 6.0, about 6.1, about 6.2, about 6.3, about 6.4, about 6.5, about 6.6, about 6.7, about 6.8, about 6.9, about 7.0, about 7.1, about 7.2, about 7.3, about 7.4, about 7.5, about 7.6, about 7.7, about 7.8, about 7.9, or about 8.0.

As described herein, the pH of the enzyme can be about 2 to 8. For example, the slurry can have a pH of about 2.0, about 2.1, about 2.2, about 2.3, about 2.4, about 2.5, about 2.6, about 2.7, about 2.8, about 2.9, about 3.0, about 3.1, about 3.2, about 3.3, about 3.4, about 3.5, about 3.6, about 3.7, about 3.8, about 3.9% (w/w), about 4.0, about 4.1, about 4.2, about 4.3, about 4.4, about 4.5, about 4.6, about 4.7, about 4.8, about 4.9, about 5.0, about 5.1, about 5.2, about 5.3, about 5.4, about 5.5, about 5.6, about 5.7, about 5.8, about 5.9, about 6.0, about 6.1, about 6.2, about 6.3, about 6.4, about 6.5, about 6.6, about 6.7, about 6.8, about 6.9, about 7.0, about 7.1, about 7.2, about 7.3, about 7.4, about 7.5, about 7.6, about 7.7, about 7.8, about 7.9, or about 8.0.

Hydrolysis.

Enzymes, as described herein, can hydrolyze proteins. For example, enzymes can hydrolyze proteins at 1% hydrolysis, about 2% hydrolysis, about 3% hydrolysis, about 4% hydrolysis, about 5% hydrolysis, about 6% hydrolysis, about 7% hydrolysis, about 8% hydrolysis, about 9% hydrolysis, about 10% hydrolysis, 11% hydrolysis, about 12% hydrolysis, about 13% hydrolysis, about 14% hydrolysis, about 15% hydrolysis, about 16% hydrolysis, about 17% hydrolysis, about 18% hydrolysis, about 19% hydrolysis, about 20% hydrolysis, 21% hydrolysis, about 22% hydrolysis, about 23% hydrolysis, about 24% hydrolysis, about 25% hydrolysis, about 26% hydrolysis, about 27% hydrolysis, about 28% hydrolysis, about 29% hydrolysis, about 30% hydrolysis, 31% hydrolysis, about 32% hydrolysis, about 33% hydrolysis, about 34% hydrolysis, about 35% hydrolysis, about 36% hydrolysis, about 37% hydrolysis, about 38% hydrolysis, about 39% hydrolysis, about 40% hydrolysis, 41% hydrolysis, about 42% hydrolysis, about 43% hydrolysis, about 44% hydrolysis, about 45% hydrolysis, about 46% hydrolysis, about 47% hydrolysis, about 48% hydrolysis, about 49% hydrolysis, about 50% hydrolysis, 51% hydrolysis, about 52% hydrolysis, about 53% hydrolysis, about 54% hydrolysis, about 55% hydrolysis, about 56% hydrolysis, about 57% hydrolysis, about 58% hydrolysis, about 59% hydrolysis, about 60% hydrolysis, 61% hydrolysis, about 62% hydrolysis, about 63% hydrolysis, about 64% hydrolysis, about 65% hydrolysis, about 66% hydrolysis, about 67% hydrolysis, about 68% hydrolysis, about 69% hydrolysis, about 70% hydrolysis, 71% hydrolysis, about 72% hydrolysis, about 73% hydrolysis, about 74% hydrolysis, about 75% hydrolysis, about 76% hydrolysis, about 77% hydrolysis, about 78% hydrolysis, about 79% hydrolysis, about 80% hydrolysis, 81% hydrolysis, about 82% hydrolysis, about 83% hydrolysis, about 84% hydrolysis, about 85% hydrolysis, about 86% hydrolysis, about 87% hydrolysis, about 88% hydrolysis, about 89% hydrolysis, about 90% hydrolysis, 91% hydrolysis, about 92% hydrolysis, about 93% hydrolysis, about 94% hydrolysis, about 95% hydrolysis, about 96% hydrolysis, about 97% hydrolysis, about 98% hydrolysis, about 99% hydrolysis, or about 100% hydrolysis. It is understood that recitation of the above discrete values includes a range between each recited value. It is understood that recitation of the above ranges includes a discrete values between each recited range.

Digestion Time/Incubation Time.

The digestion time (i.e., incubation time), as described herein, can be any length of time the slurry is in contact with an enzyme sufficient to digest a protein component of the slurry. For example, the digestion time can be from about 30 minutes to about 120 minutes. As another example, the digestion time can be about 1 minute, about 2 minutes, about 3 minutes, about 4 minutes, about 5 minutes, about 6 minutes, about 7 minutes, about 8 minutes, about 9 minutes, about 10 minutes, about 11 minutes, about 12 minutes, about 13 minutes, about 14 minutes, about 15 minutes, about 16 minutes, about 17 minutes, about 18 minutes, about 19 minutes, about 20 minutes, about 21 minutes, about 22 minutes, about 23 minutes, about 24 minutes, about 25 minutes, about 26 minutes, about 27 minutes, about 28 minutes, about 29 minutes, about 30 minutes, about 31 minutes, about 32 minutes, about 33 minutes, about 34 minutes, about 35 minutes, about 36 minutes, about 37 minutes, about 38 minutes, about 39 minutes, about 40 minutes, about 41 minutes, about 42 minutes, about 43 minutes, about 44 minutes, about 45 minutes, about 46 minutes, about 47 minutes, about 48 minutes, about 49 minutes, about 50 minutes, about 51 minutes, about 52 minutes, about 53 minutes, about 54 minutes, about 55 minutes, about 56 minutes, about 57 minutes, about 58 minutes, about 59 minutes, about 60 minutes, about 61 minutes, about 62 minutes, about 63 minutes, about 64 minutes, about 65 minutes, about 66 minutes, about 67 minutes, about 68 minutes, about 69 minutes, about 70 minutes, about 71 minutes, about 72 minutes, about 73 minutes, about 74 minutes, about 75 minutes, about 76 minutes, about 77 minutes, about 78 minutes, about 79 minutes, about 80 minutes, about 81 minutes, about 82 minutes, about 83 minutes, about 84 minutes, about 85 minutes, about 86 minutes, about 87 minutes, about 88 minutes, about 89 minutes, about 90 minutes, about 91 minutes, about 92 minutes, about 93 minutes, about 94 minutes, about 95 minutes, about 96 minutes, about 97 minutes, about 98 minutes, about 99 minutes, about 100 minutes, about 101 minutes, about 102 minutes, about 103 minutes, about 104 minutes, about 105 minutes, about 106 minutes, about 107 minutes, about 108 minutes, about 109 minutes, about 110 minutes, about 111 minutes, about 112 minutes, about 113 minutes, about 114 minutes, about 115 minutes, about 116 minutes, about 117 minutes, about 118 minutes, about 119 minutes, about 120 minutes, about 121 minutes, about 122 minutes, about 123 minutes, about 124 minutes, about 125 minutes, about 126 minutes, about 127 minutes, about 128 minutes, about 129 minutes, about 130 minutes, about 131 minutes, about 132 minutes, about 133 minutes, about 134 minutes, about 135 minutes, about 136 minutes, about 37 minutes, about 138 minutes, about 139 minutes, about 140 minutes, about 141 minutes, about 142 minutes, about 143 minutes, about 144 minutes, about 145 minutes, about 146 minutes, about 147 minutes, about 148 minutes, about 149 minutes, about 150 minutes, about 151 minutes, about 152 minutes, about 153 minutes, about 154 minutes, about 155 minutes, about 156 minutes, about 157 minutes, about 158 minutes, about 159 minutes, about 160 minutes, about 161 minutes, about 162 minutes, about 163 minutes, about 164 minutes, about 165 minutes, about 166 minutes, about 167 minutes, about 168 minutes, about 169 minutes, about 170 minutes, about 171 minutes, about 172 minutes, about 173 minutes, about 174 minutes, about 175 minutes, about 176 minutes, about 177 minutes, about 178 minutes, about 179 minutes, about 180 minutes, about 181 minutes, about 182 minutes, about 183 minutes, about 184 minutes, about 185 minutes, about 186 minutes, about 187 minutes, about 188 minutes, about 189 minutes, about 190 minutes, about 191 minutes, about 192 minutes, about 193 minutes, about 194 minutes, about 195 minutes, about 196 minutes, about 197 minutes, about 198 minutes, about 199 minutes, about 200 minutes, about 201 minutes, about 202 minutes, about 203 minutes, about 204 minutes, about 205 minutes, about 206 minutes, about 207 minutes, about 208 minutes, about 209 minutes, about 210 minutes, about 211 minutes, about 212 minutes, about 213 minutes, about 214 minutes, about 215 minutes, about 216 minutes, about 217 minutes, about 218 minutes, about 219 minutes, about 220 minutes, about 221 minutes, about 222 minutes, about 223 minutes, about 224 minutes, about 225 minutes, about 226 minutes, about 227 minutes, about 228 minutes, about 229 minutes, about 230 minutes, about 231 minutes, about 232 minutes, about 233 minutes, about 234 minutes, about 235 minutes, about 236 minutes, about 237 minutes, about 238 minutes, about 239 minutes, about 240 minutes, about 241 minutes, about 242 minutes, about 243 minutes, about 244 minutes, about 245 minutes, about 246 minutes, about 247 minutes, about 248 minutes, about 249 minutes, about 250 minutes, about 251 minutes, about 252 minutes, about 253 minutes, about 254 minutes, about 255 minutes, about 256 minutes, about 257 minutes, about 258 minutes, about 259 minutes, about 260 minutes, about 261 minutes, about 262 minutes, about 263 minutes, about 264 minutes, about 265 minutes, about 626 minutes, about 267 minutes, about 268 minutes, about 269 minutes, about 270 minutes, about 271 minutes, about 272 minutes, about 273 minutes, about 274 minutes, about 275 minutes, about 276 minutes, about 277 minutes, about 278 minutes, about 279 minutes, about 280 minutes, about 281 minutes, about 282 minutes, about 283 minutes, about 284 minutes, about 285 minutes, about 286 minutes, about 287 minutes, about 288 minutes, about 289 minutes, about 290 minutes, about 291 minutes, about 292 minutes, about 293 minutes, about 294 minutes, about 295 minutes, about 296 minutes, about 297 minutes, about 298 minutes, about 299 minutes, or about 300 minutes. It is understood that recitation of the above discrete values includes a range between each recited value. It is understood that recitation of the above ranges includes a discrete values between each recited range.

Soluble Protein.

The soluble protein, as described herein, can be any amount suitable for a particular food preparation. For example, the soluble protein can be about 20% to about 100%. As another example, the soluble protein can be about 1% soluble protein, about 2% soluble protein, about 3% soluble protein, about 4% soluble protein, about 5% soluble protein, about 6% soluble protein, about 7% soluble protein, about 8% soluble protein, about 9% soluble protein, about 10% soluble protein, 11% soluble protein, about 12% soluble protein, about 13% soluble protein, about 14% soluble protein, about 15% soluble protein, about 16% soluble protein, about 17% soluble protein, about 18% soluble protein, about 19% soluble protein, about 20% soluble protein, 21% soluble protein, about 22% soluble protein, about 23% soluble protein, about 24% soluble protein, about 25% soluble protein, about 26% soluble protein, about 27% soluble protein, about 28% soluble protein, about 29% soluble protein, about 30% soluble protein, 31% soluble protein, about 32% soluble protein, about 33% soluble protein, about 34% soluble protein, about 35% soluble protein, about 36% soluble protein, about 37% soluble protein, about 38% soluble protein, about 39% soluble protein, about 40% soluble protein, 41% soluble protein, about 42% soluble protein, about 43% soluble protein, about 44% soluble protein, about 45% soluble protein, about 46% soluble protein, about 47% soluble protein, about 48% soluble protein, about 49% soluble protein, about 50% soluble protein, 51% soluble protein, about 52% soluble protein, about 53% soluble protein, about 54% soluble protein, about 55% soluble protein, about 56% soluble protein, about 57% soluble protein, about 58% soluble protein, about 59% soluble protein, about 60% soluble protein, 61% soluble protein, about 62% soluble protein, about 63% soluble protein, about 64% soluble protein, about 65% soluble protein, about 66% soluble protein, about 67% soluble protein, about 68% soluble protein, about 69% soluble protein, about 70% soluble protein, 71% soluble protein, about 72% soluble protein, about 73% soluble protein, about 74% soluble protein, about 75% soluble protein, about 76% soluble protein, about 77% soluble protein, about 78% soluble protein, about 79% soluble protein, about 80% soluble protein, 81% soluble protein, about 82% soluble protein, about 83% soluble protein, about 84% soluble protein, about 85% soluble protein, about 86% soluble protein, about 87% soluble protein, about 88% soluble protein, about 89% soluble protein, about 90% soluble protein, 91% soluble protein, about 92% soluble protein, about 93% soluble protein, about 94% soluble protein, about 95% soluble protein, about 96% soluble protein, about 97% soluble protein, about 98% soluble protein, about 99% soluble protein, or about 100% soluble protein.

Temperature.

The temperature, as described herein, can be any temperature sufficient to digest the protein component of the slurry. For example, the temperature can be about 45° C. to about 60° C. As another example, the temperature can be about 1° C., about 2° C., about 3° C., about 4° C., about 5° C., about 6° C., about 7° C., about 8° C., about 9° C., about 10° C., 11° C., about 12° C., about 13° C., about 14° C., about 15° C., about 16° C., about 17° C., about 18° C., about 19° C., about 20° C., 21° C., about 22° C., about 23° C., about 24° C., about 25° C., about 26° C., about 27° C., about 28° C., about 29° C., about 30° C., 31° C., about 32° C., about 33° C., about 34° C., about 35° C., about 36° C., about 37° C., about 38° C., about 39° C., about 40° C., 41° C., about 42° C., about 43° C., about 44° C., about 45° C., about 46° C., about 47° C., about 48° C., about 49° C., about 50° C., 51° C., about 52° C., about 53° C., about 54° C., about 55° C., about 56° C., about 57° C., about 58° C., about 59° C., about 60° C., 61° C., about 62° C., about 63° C., about 64° C., about 65° C., about 66° C., about 67° C., about 68° C., about 69° C., about 70° C., 71° C., about 72° C., about 73° C., about 74° C., about 75° C., about 76° C., about 77° C., about 78° C., about 79° C., about 80° C., 81° C., about 82° C., about 83° C., about 84° C., about 85° C., about 86° C., about 87° C., about 88° C., about 89° C., about 90° C., 91° C., about 92° C., about 93° C., about 94° C., about 95° C., about 96° C., about 97° C., about 98° C., about 99° C., or about 100° C. It is understood that recitation of the above discrete values includes a range between each recited value. It is understood that recitation of the above ranges includes a discrete values between each recited range.

Drying.

Methods, as described herein, can comprise a drying process. Drying processes are well known. Except as otherwise noted herein, therefore, the process of the present disclosure can be carried out in accordance with such processes.

As described herein, an insect product can be dried or substantially dried. Drying can include any drying method known in the art. In some embodiments, drying can include spray drying or drum drying. In another embodiment, drying can include heat drying, spray drying, freeze drying, tray drying, air drying, vacuum drying, drum drying, or a combination thereof. For example, dryers, such as ovens, impingement ovens, freeze dryers, heat dryers, or hot air or vacuum dryers may be used. In another embodiment, spray drying can be used to dry the insect slurry into a dried insect product. In yet another embodiment, drum drying can be used to dry the insect slurry into a dried insect product. In another embodiment, drying can include ultrafiltration (e.g., used to concentrate protein and thus supplants some portion of drying procedure); oven drying; vacuum oven drying; infrared drying; thin film drying; drum drying; microwave drying; high electric field drying; refractance window drying; heat pump drying; spray drying; lyophilization/freeze drying; or air drying. As another example, filtration methods, as described herein, can be used a drying step or pre-drying concentration step.

As described herein, a “dried insect product” or a “substantially dried insect product” can refer to an insect product (e.g., powder, flakes, meal) comprising water in an amount of about 15% by weight or less of the dried or substantially dried insect product. For example, in one embodiment, the dried insect product can comprise water in an amount of less than about 10% by weight. In another embodiment, the dried insect product can comprise water in an amount of less than about 5.0% by weight of the dried insect product. In yet another embodiment, the dried insect product can comprise water in amount from less than about 3.0% by weight of the dried insect product. In a further embodiment, the dried insect product can comprise water in amount from less than about 2.0% by weight of the dried insect product. In another embodiment, the dried insect product can comprise water in an amount from about 0.01% to about 15% by weight of the dried composition. In yet another embodiment, the dried insect product can comprise water in an amount from about 0.01% to about 5% by weight of the dried composition. In a further embodiment, the dried insect product can comprise water in an amount from about 0.0% to about 15% by weight of the dried composition. In a further embodiment, the dried insect product can comprise water in an amount less than about 1% by weight of the dried composition. It is understood that recitation of the above range of values includes discrete values between each recited range.

The drying time, as described herein, can be any length of time for a product according to the present disclosure takes to dry or substantially dry. For example, the drying time can be from about 30 minutes to about 120 minutes. As another example, the drying time can be from 1 day to about 7 days, or about two weeks. As another example, the drying time can be about 1 minute, about 2 minutes, about 3 minutes, about 4 minutes, about 5 minutes, about 6 minutes, about 7 minutes, about 8 minutes, about 9 minutes, about 10 minutes, about 11 minutes, about 12 minutes, about 13 minutes, about 14 minutes, about 15 minutes, about 16 minutes, about 17 minutes, about 18 minutes, about 19 minutes, about 20 minutes, about 21 minutes, about 22 minutes, about 23 minutes, about 24 minutes, about 25 minutes, about 26 minutes, about 27 minutes, about 28 minutes, about 29 minutes, about 30 minutes, about 31 minutes, about 32 minutes, about 33 minutes, about 34 minutes, about 35 minutes, about 36 minutes, about 37 minutes, about 38 minutes, about 39 minutes, about 40 minutes, about 41 minutes, about 42 minutes, about 43 minutes, about 44 minutes, about 45 minutes, about 46 minutes, about 47 minutes, about 48 minutes, about 49 minutes, about 50 minutes, about 51 minutes, about 52 minutes, about 53 minutes, about 54 minutes, about 55 minutes, about 56 minutes, about 57 minutes, about 58 minutes, about 59 minutes, about 60 minutes, about 61 minutes, about 62 minutes, about 63 minutes, about 64 minutes, about 65 minutes, about 66 minutes, about 67 minutes, about 68 minutes, about 69 minutes, about 70 minutes, about 71 minutes, about 72 minutes, about 73 minutes, about 74 minutes, about 75 minutes, about 76 minutes, about 77 minutes, about 78 minutes, about 79 minutes, about 80 minutes, about 81 minutes, about 82 minutes, about 83 minutes, about 84 minutes, about 85 minutes, about 86 minutes, about 87 minutes, about 88 minutes, about 89 minutes, about 90 minutes, about 91 minutes, about 92 minutes, about 93 minutes, about 94 minutes, about 95 minutes, about 96 minutes, about 97 minutes, about 98 minutes, about 99 minutes, about 100 minutes, about 101 minutes, about 102 minutes, about 103 minutes, about 104 minutes, about 105 minutes, about 106 minutes, about 107 minutes, about 108 minutes, about 109 minutes, about 110 minutes, about 111 minutes, about 112 minutes, about 113 minutes, about 114 minutes, about 115 minutes, about 116 minutes, about 117 minutes, about 118 minutes, about 119 minutes, about 120 minutes, about 121 minutes, about 122 minutes, about 123 minutes, about 124 minutes, about 125 minutes, about 126 minutes, about 127 minutes, about 128 minutes, about 129 minutes, about 130 minutes, about 131 minutes, about 132 minutes, about 133 minutes, about 134 minutes, about 135 minutes, about 136 minutes, about 37 minutes, about 138 minutes, about 139 minutes, about 140 minutes, about 141 minutes, about 142 minutes, about 143 minutes, about 144 minutes, about 145 minutes, about 146 minutes, about 147 minutes, about 148 minutes, about 149 minutes, about 150 minutes, about 151 minutes, about 152 minutes, about 153 minutes, about 154 minutes, about 155 minutes, about 156 minutes, about 157 minutes, about 158 minutes, about 159 minutes, about 160 minutes, about 161 minutes, about 162 minutes, about 163 minutes, about 164 minutes, about 165 minutes, about 166 minutes, about 167 minutes, about 168 minutes, about 169 minutes, about 170 minutes, about 171 minutes, about 172 minutes, about 173 minutes, about 174 minutes, about 175 minutes, about 176 minutes, about 177 minutes, about 178 minutes, about 179 minutes, about 180 minutes, about 181 minutes, about 182 minutes, about 183 minutes, about 184 minutes, about 185 minutes, about 186 minutes, about 187 minutes, about 188 minutes, about 189 minutes, about 190 minutes, about 191 minutes, about 192 minutes, about 193 minutes, about 194 minutes, about 195 minutes, about 196 minutes, about 197 minutes, about 198 minutes, about 199 minutes, about 200 minutes, about 201 minutes, about 202 minutes, about 203 minutes, about 204 minutes, about 205 minutes, about 206 minutes, about 207 minutes, about 208 minutes, about 209 minutes, about 210 minutes, about 211 minutes, about 212 minutes, about 213 minutes, about 214 minutes, about 215 minutes, about 216 minutes, about 217 minutes, about 218 minutes, about 219 minutes, about 220 minutes, about 221 minutes, about 222 minutes, about 223 minutes, about 224 minutes, about 225 minutes, about 226 minutes, about 227 minutes, about 228 minutes, about 229 minutes, about 230 minutes, about 231 minutes, about 232 minutes, about 233 minutes, about 234 minutes, about 235 minutes, about 236 minutes, about 237 minutes, about 238 minutes, about 239 minutes, about 240 minutes, about 241 minutes, about 242 minutes, about 243 minutes, about 244 minutes, about 245 minutes, about 246 minutes, about 247 minutes, about 248 minutes, about 249 minutes, about 250 minutes, about 251 minutes, about 252 minutes, about 253 minutes, about 254 minutes, about 255 minutes, about 256 minutes, about 257 minutes, about 258 minutes, about 259 minutes, about 260 minutes, about 261 minutes, about 262 minutes, about 263 minutes, about 264 minutes, about 265 minutes, about 626 minutes, about 267 minutes, about 268 minutes, about 269 minutes, about 270 minutes, about 271 minutes, about 272 minutes, about 273 minutes, about 274 minutes, about 275 minutes, about 276 minutes, about 277 minutes, about 278 minutes, about 279 minutes, about 280 minutes, about 281 minutes, about 282 minutes, about 283 minutes, about 284 minutes, about 285 minutes, about 286 minutes, about 287 minutes, about 288 minutes, about 289 minutes, about 290 minutes, about 291 minutes, about 292 minutes, about 293 minutes, about 294 minutes, about 295 minutes, about 296 minutes, about 297 minutes, about 298 minutes, about 299 minutes, or about 300 minutes. It is understood that recitation of the above discrete values includes a range between each recited value. It is understood that recitation of the above ranges includes a discrete values between each recited range.

Filtration.

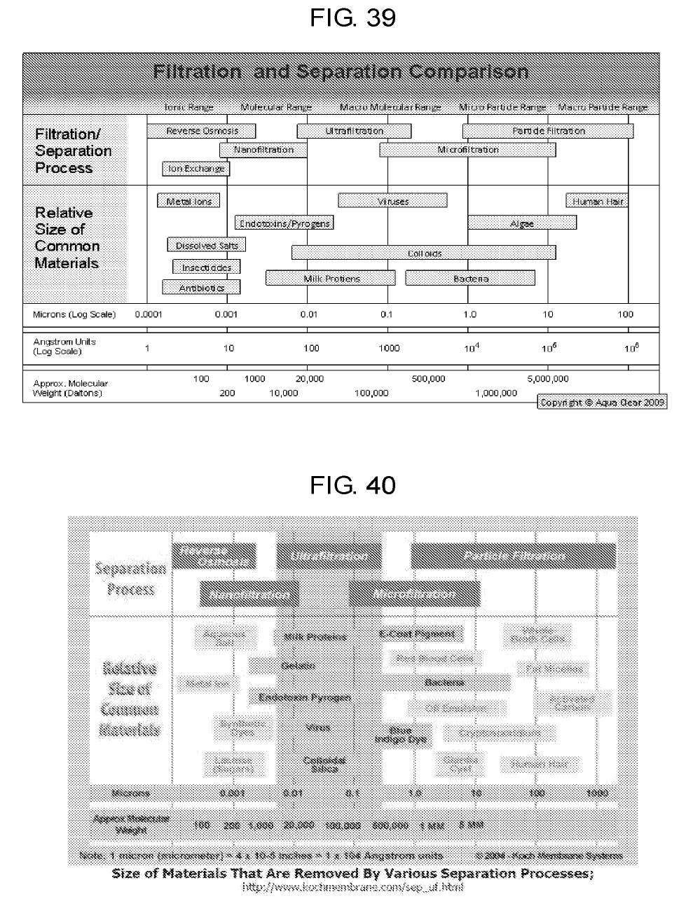

Methods, as described herein, can comprise a filtration process. Filtration processes are well known; see e.g., Zeman, Microfiltration and Ultrafiltration: Principles and Applications, CRC Press, Jul. 9, 1996, 642 pages. Except as otherwise noted herein, therefore, the process of the present disclosure can be carried out in accordance with such processes. FIGS. 39-40 illustrate various filtration processes known in the art, therefore, the process of the present disclosure can be carried out in accordance with such processes.

For example, such filtration methods can be used to separate protein from the lipids and complex carbohydrates (e.g., chitin) components of the slurry. As another example, such filtration methods can be used a pre-drying concentration step.

In some embodiments, the insect slurry can be filtered using microfiltration, ultrafiltration, nanofiltration, or reverse osmosis.

In some embodiments the insect slurry can be filtered using microfiltration and the permeate from the microfiltration can be filtered using ultrafiltration.

Reverse Osmosis.

In some embodiments, reverse osmosis can be used to remove particles less than about 0.005 μm or between about 0.0001 μm and about 0.005 μm. For example, reverse osmosis can be used to remove particles from about 0.0001 μm, about 0.0002 μm, about 0.0003 μm, about 0.0004 μm, about 0.0005 μm, about 0.0006 μm, about 0.0007 μm, about 0.0008 μm, about 0.0009 μm, about 0.001 μm, about 0.002 μm, about 0.003 μm, about 0.004 μm, or about 0.005 μm. It is understood that recitation of the above discrete values includes a range between each recited value. It is understood that recitation of the above ranges includes a discrete values between each recited range.

Nanofiltration.

In some embodiments, nanofiltration can be used to remove particles less than about 0.01 μm or between about 0.0005 μm and about 0.01 μm. For example, nanofiltration can be used to remove particles from about 0.0005 μm, about 0.0006 μm, about 0.0007 μm, about 0.0008 μm, about 0.0009 μm, about 0.001 μm, about 0.002 μm, about 0.003 μm, about 0.004 μm, about 0.005 μm, about 0.006 μm, about 0.007 μm, about 0.008 μm, about 0.009 μm, or about 0.01 μm. It is understood that recitation of the above discrete values includes a range between each recited value. It is understood that recitation of the above ranges includes a discrete values between each recited range.

Ultrafiltration.

In some embodiments, ultrafiltration can be used to remove particles less than about 0.5 μm or between about 0.007 μm and about 0.5 μm. For example, ultrafiltration can be used to remove particles from about 0.007 μm, about 0.008 μm, about 0.009 μm, about 0.01 μm, about 0.02 μm, about 0.03 μm, about 0.04 μm, about 0.05 μm, about 0.06 μm, about 0.07 μm, about 0.08 μm, about 0.09 μm, about 0.1 μm, about 0.2 μm, about 0.3 μm, about 0.4 μm, or about 0.5 μm. It is understood that recitation of the above discrete values includes a range between each recited value. It is understood that recitation of the above ranges includes a discrete values between each recited range.

In some embodiments, ultrafiltration filters or membranes can have a pore size between about 1 kDa and about 100 kDa. For example, ultrafiltration filters or membranes can have a pore size of about 1 kDa, about 2 kDa, about 3 kDa, about 4 kDa, about 5 kDa, about 6 kDa, about 7 kDa, about 8 kDa, about 9 kDa, about 10 kDa, 11 kDa, about 12 kDa, about 13 kDa, about 14 kDa, about 15 kDa, about 16 kDa, about 17 kDa, about 18 kDa, about 19 kDa, about 20 kDa, 21 kDa, about 22 kDa, about 23 kDa, about 24 kDa, about 25 kDa, about 26 kDa, about 27 kDa, about 28 kDa, about 29 kDa, about 30 kDa, 31 kDa, about 32 kDa, about 33 kDa, about 34 kDa, about 35 kDa, about 36 kDa, about 37 kDa, about 38 kDa, about 39 kDa, about 40 kDa, 41 kDa, about 42 kDa, about 43 kDa, about 44 kDa, about 45 kDa, about 46 kDa, about 47 kDa, about 48 kDa, about 49 kDa, about 50 kDa, 51 kDa, about 52 kDa, about 53 kDa, about 54 kDa, about 55 kDa, about 56 kDa, about 57 kDa, about 58 kDa, about 59 kDa, about 60 kDa, 61 kDa, about 62 kDa, about 63 kDa, about 64 kDa, about 65 kDa, about 66 kDa, about 67 kDa, about 68 kDa, about 69 kDa, about 70 kDa, 71 kDa, about 72 kDa, about 73 kDa, about 74 kDa, about 75 kDa, about 76 kDa, about 77 kDa, about 78 kDa, about 79 kDa, about 80 kDa, 81 kDa, about 82 kDa, about 83 kDa, about 84 kDa, about 85 kDa, about 86 kDa, about 87 kDa, about 88 kDa, about 89 kDa, about 90 kDa, 91 kDa, about 92 kDa, about 93 kDa, about 94 kDa, about 95 kDa, about 96 kDa, about 97 kDa, about 98 kDa, about 99 kDa, or about 100 kDa. It is understood that recitation of the above discrete values includes a range between each recited value. It is understood that recitation of the above ranges includes a discrete values between each recited range.

Microfiltration.

In some embodiments, microfiltration can be used to remove particles less than about 20 μm or between about 0.07 μm and about 20 μm. For example, microfiltration can be used to remove particles from about 0.07 μm, about 0.08 μm, about 0.09 μm, about 0.1 μm, about 0.2 μm, about 0.3 μm, about 0.4 μm, about 0.5 μm, about 0.6 μm, about 0.7 μm, about 0.8 μm, about 0.9 μm, about 1 μm, about 2 μm, about 3 μm, about 4 μm, about 5 μm, about 6 μm, about 7 μm, about 8 μm, about 9 μm, about 10 μm, about 11 μm, about 12 μm, about 13 μm, about 14 μm, about 15 μm, about 16 μm, about 17 μm, about 19 μm, about 19 μm, or about 20 μm. It is understood that recitation of the above discrete values includes a range between each recited value. It is understood that recitation of the above ranges includes a discrete values between each recited range.

In some embodiments, microfiltration filters or membranes can have a pore size between about 0.1 μm and about 10 μm. For example, microfiltration filters or membranes can have a pore size of about 0.1 μm, about 0.2 μm, about 0.3 μm, about 0.4 μm, about 0.5 μm, about 0.6 μm, about 0.7 μm, about 0.8 μm, about 0.9 μm, about 1 μm, about 2 μm, about 3 μm, about 4 μm, about 5 μm, about 6 μm, about 7 μm, about 8 μm, about 9 μm, or about 10 μm, or about 20 μm. It is understood that recitation of the above discrete values includes a range between each recited value. It is understood that recitation of the above ranges includes a discrete values between each recited range.

Particle Filtration. In some embodiments, particle filtration can be used to remove particles less than about 1000 μm or between about 0.7 μm and about 1000 μm. For example, particle filtration can be used to remove particles from about 0.7 μm, about 0.8 μm, about 0.9 μm, about 1 μm, about 2 μm, about 3 μm, about 4 μm, about 5 μm, about 6 μm, about 7 μm, about 8 μm, about 9 μm, about 10 μm, about 20 μm, about 30 μm, about 40 μm, about 50 μm, about 60 μm, about 70 μm, about 80 μm, about 90 μm, about 100 μm, about 200 μm, about 300 μm, about 400 μm, about 500 μm, about 600 μm, about 700 μm, about 800 μm, about 900 μm, or about 1000 μm. It is understood that recitation of the above discrete values includes a range between each recited value. It is understood that recitation of the above ranges includes a discrete values between each recited range.

Definitions and methods described herein are provided to better define the present disclosure and to guide those of ordinary skill in the art in the practice of the present disclosure. Unless otherwise noted, terms are to be understood according to conventional usage by those of ordinary skill in the relevant art.

In some embodiments, numbers expressing quantities of ingredients, properties such as molecular weight, reaction conditions, and so forth, used to describe and claim certain embodiments of the present disclosure are to be understood as being modified in some instances by the term “about.” In some embodiments, the term “about” is used to indicate that a value includes the standard deviation of the mean for the device or method being employed to determine the value. In some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the present disclosure are approximations, the numerical values set forth in the specific examples are reported as precisely as practicable. The numerical values presented in some embodiments of the present disclosure may contain certain errors necessarily resulting from the standard deviation found in their respective testing measurements. The recitation of ranges of values herein is merely intended to serve as a shorthand method of referring individually to each separate value falling within the range. Unless otherwise indicated herein, each individual value is incorporated into the specification as if it were individually recited herein. It is understood that recitation of the discrete values includes a range between each recited value. It is understood that recitation of ranges includes a discrete values between each recited range.

As used herein, the term “about” and/or “substantially” can refer to a +/−10% variation from the nominal value/term. Such variation is always included in any given value/term provided herein, whether or not such variation is specifically referred thereto.

If any disclosures are incorporated herein by reference and such disclosures conflict in part and/or in whole with the present disclosure, then to the extent of conflict, and/or broader disclosure, and/or broader definition of terms, the present disclosure controls. If such disclosures conflict in part and/or in whole with one another, then to the extent of conflict, the later-dated disclosure controls

In some embodiments, the terms “a” and “an” and “the” and similar references used in the context of describing a particular embodiment (especially in the context of certain of the following claims) can be construed to cover both the singular and the plural, unless specifically noted otherwise. In some embodiments, the term “or” as used herein, including in the claims, is used to mean “and/or” unless explicitly indicated to refer to alternatives only or the alternatives are mutually exclusive.

The terms “comprise,” “have” and “include” are open-ended linking verbs. Any forms or tenses of one or more of these verbs, such as “comprises,” “comprising,” “has,” “having,” “includes” and “including,” are also open-ended. For example, any method that “comprises,” “has” or “includes” one or more steps is not limited to possessing only those one or more steps and can also cover other unlisted steps. Similarly, any composition or device that “comprises,” “has” or “includes” one or more features is not limited to possessing only those one or more features and can cover other unlisted features.

All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the present disclosure and does not pose a limitation on the scope of the present disclosure otherwise claimed. No language in the specification should be construed as indicating any non-claimed element essential to the practice of the present disclosure.

Groupings of alternative elements or embodiments of the present disclosure disclosed herein are not to be construed as limitations. Each group member can be referred to and claimed individually or in any combination with other members of the group or other elements found herein. One or more members of a group can be included in, or deleted from, a group for reasons of convenience or patentability. When any such inclusion or deletion occurs, the specification is herein deemed to contain the group as modified thus fulfilling the written description of all Markush groups used in the appended claims.

Citation of a reference herein shall not be construed as an admission that such is prior art to the present disclosure.

Having described the present disclosure in detail, it will be apparent that modifications, variations, and equivalent embodiments are possible without departing the scope of the present disclosure defined in the appended claims. Furthermore, it should be appreciated that all examples in the present disclosure are provided as non-limiting examples.

### EXAMPLES

The following non-limiting examples are provided to further illustrate the present disclosure. It should be appreciated by those of skill in the art that the techniques disclosed in the following examples represent various approaches that have been found to function well in the practice of the present disclosure, and thus can be considered to constitute examples of modes for its practice. However, those of skill in the art should, in light of the present disclosure, appreciate that many changes can be made in the specific embodiments that are disclosed and still obtain a like or similar result without departing from the spirit and scope of the present disclosure.

### Example 1: Protein Recovery from Whole Crickets (I)

A given mass of proteinaceous animal matter is ground into a fine paste. The paste is then diluted with distilled water to form a dilute slurry. Protease enzymes are added to the slurry and used to digest the protein component of the slurry. After enzymatic digestion, the slurry is passed through a filtration system to separate the non-protein solids from the protein fraction. The dilute protein fraction is then concentrated by a different type of filtration with a smaller pore size. The concentrated protein is then dried to remove enough water to generate a shelf-stable protein isolate.

More specifically, whole crickets (Acheta domesticus) are ground into a fine paste. The paste is diluted by a factor of approximately 5-15 to yield a dilute slurry. Protease enzymes are added to the slurry in order to partially solubilize the protein present in the crickets and liberate it from chitin or any other macromolecules to which it is bound. After enzymatic digestion, the slurry is passed through a microfiltration system using membranes with pore sizes ranging from 0.1-1 μm. The filter retains lipids and insoluble sediment, including chitin, whereas proteins are able to pass through. The retentate is collected and removed from the system, and the permeate is passed through a second filtration system consisting of ultrafiltration membranes with pore sizes of 3-50 kDa. This filter retains proteins and peptides, whereas water and small solutes such as ash pass through the filter, allowing the protein to be concentrated. Once concentrated to the fullest extent possible in the filtration system, the protein retentate is dried and packaged to yield a shelf-stable protein isolate.

### Example 2: Protein Recovery from Whole Crickets (II)

Whole crickets (Acheta domesticus) are sheared into a fine paste using a blade blender at 2500-3000 rpm. Approximately 1 kg paste is diluted with 10 L deionized water under shear to yield a homogenous slurry. A mixture of protease and peptidase enzymes is added to the slurry (1% w/w). The mixture is then heated to 60° C. for 1 hour in order to partially solubilize the protein present in the crickets and liberate it from chitin and any other macromolecules to which it is bound. Approximately 60-80% of the cricket is made soluble by the enzymes in this step. After enzymatic digestion, the slurry is passed through a microfiltration system using membranes with pore sizes ranging from 0.1-1 μm. The filter retains lipids and insoluble sediment, including chitin, whereas proteins are able to pass through. The yield of the microfiltration step is approximately 90-95% of the total solubilized protein component of the mixture. The retentate is collected and removed from the system, and the permeate is passed through a second filtration system consisting of ultrafiltration membranes with pore sizes of 3-50 kDa. This filter retains proteins and peptides, whereas water and small solutes such as ash pass through the filter, allowing the protein to be concentrated. Once concentrated to approximately 20-50% protein in the filtration system, the protein retentate is dried and packaged to yield a shelf-stable protein isolate. The total yield of the process is approximately 60-80% of the total protein content of the whole crickets.

### Example 3: Protein Recovery from Whole Crickets (III)

The dried cricket powder can be prepared by a variety of processes. The dried cricket powder is prepared with whole crickets that are dried out (using a conventional oven) or a spray dryer (if the whole crickets are slurried first) and then ground. The cricket powder was also purchase from Next Millennium Farms.

Dried cricket powder is mixed with water and mixed with water to create an initial slurry. The powder is then diluted with water to form a slurry. Enzymes are added to the slurry and used to digest the protein component of the slurry. After enzymatic digestion, the slurry is passed through a filtration system to separate the non-protein solids from the protein fraction. The dilute protein fraction is then concentrated by a different type of filtration with a smaller pore size. The concentrated protein is then dried to remove enough water to generate a shelf-stable protein isolate.

### Example 4: Characterization and Composition of Products

Solubility range of the final insect product is between about 20% and about 99%.

The particle size of the initial grind is about 10-200 μm. The particle size of the final product is about 0.01-10 μm.

The protein composition of the raw cricket powder is about 50-70%. The fat composition of the raw cricket powder is about 20-30%. The carbohydrate composition of the raw cricket powder is about 5-15%. The ash composition of the raw (e.g., dried) cricket powder is about 2-6%.

The microfiltered permeate has a protein composition of about 1-10%. The microfiltered permeate has a fat composition of about 0-5%. The microfiltered permeate has a carbohydrate composition of about 0-5%. The microfiltered permeate has an ash protein composition of about 0-5%.

The wet concentrate is the products following microfiltration and ultrafiltration, prior to drying. The wet concentrate has a protein composition of about 10-50%. The wet concentrate has a fat composition of about 0-5%. The wet concentrate has a carbohydrate composition of about 0-5%. The wet concentrate has an ash composition of about 0-5%.

The dried final product has a protein composition of about 90-99%. The dried final product has a fat composition of about 0-5%. The dried final product has a carbohydrate composition of about 0-5%. The dried final product has an ash composition of about 0-5%.

### Example 5: Amino Acid Analysis (I)

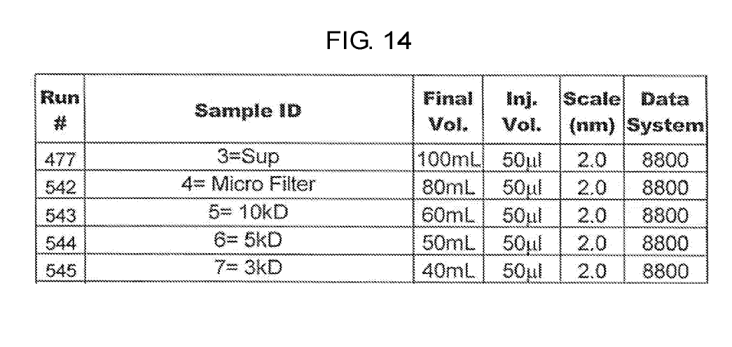

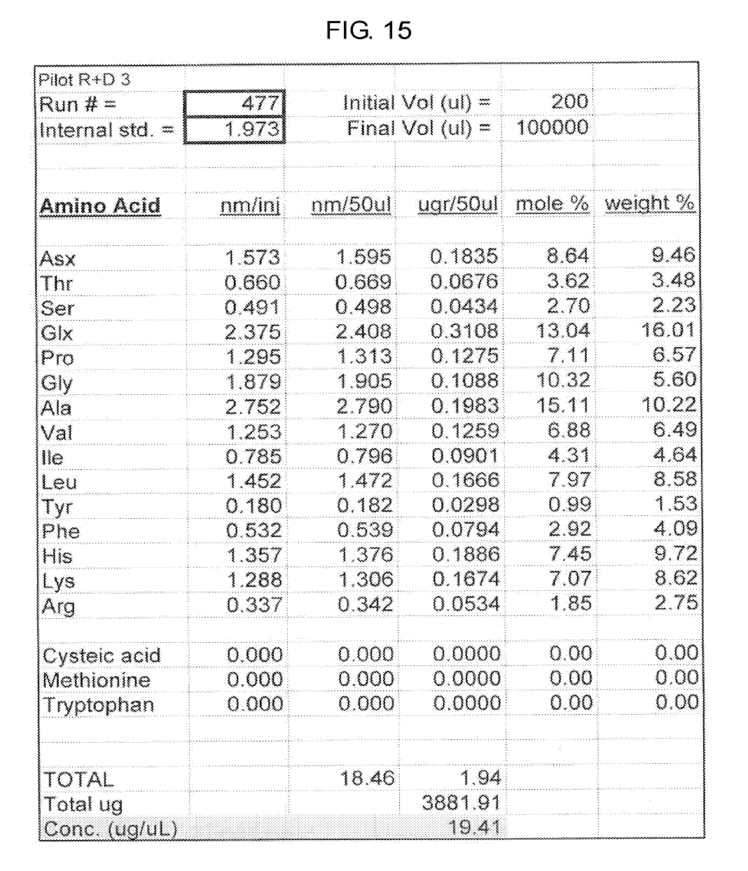

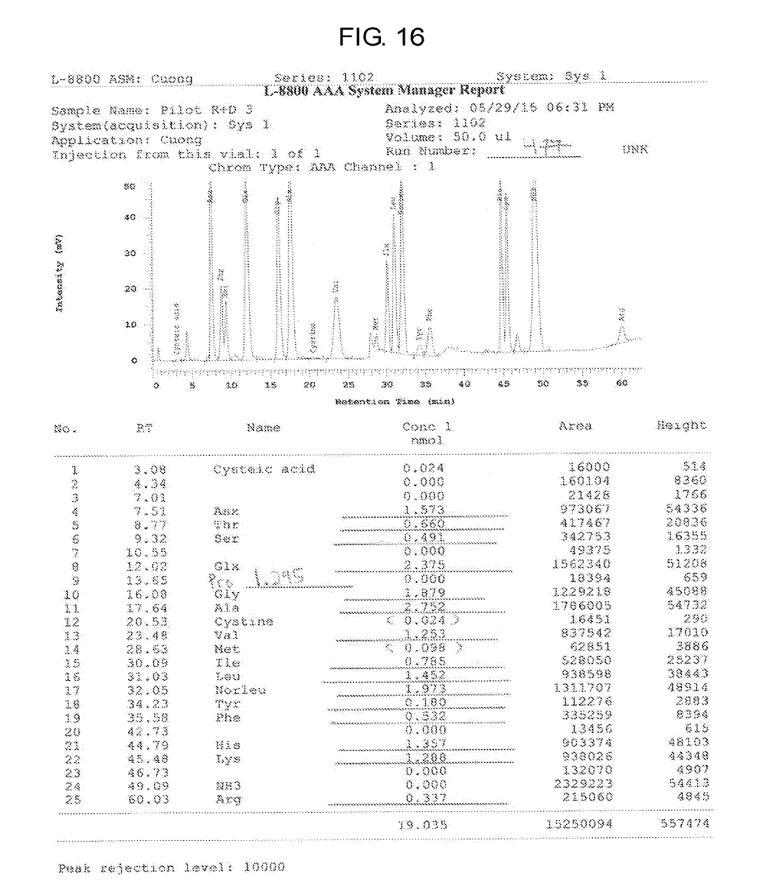

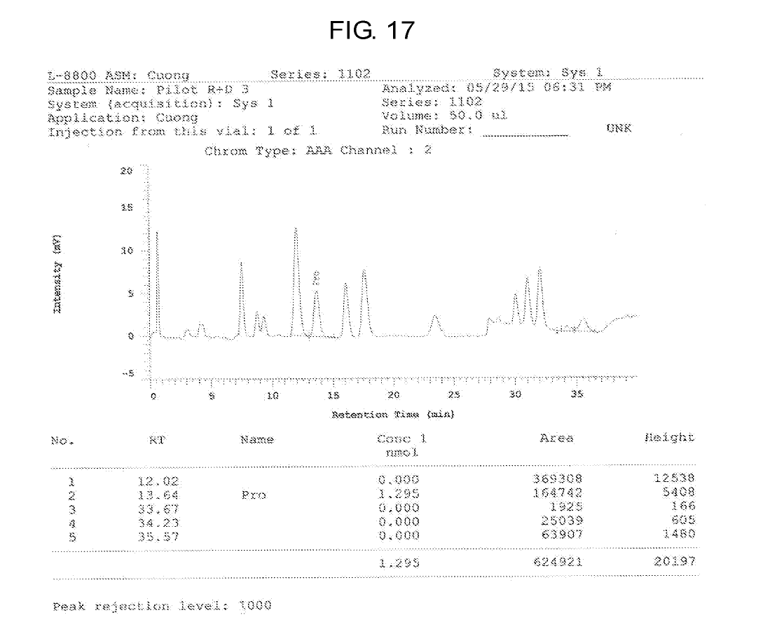

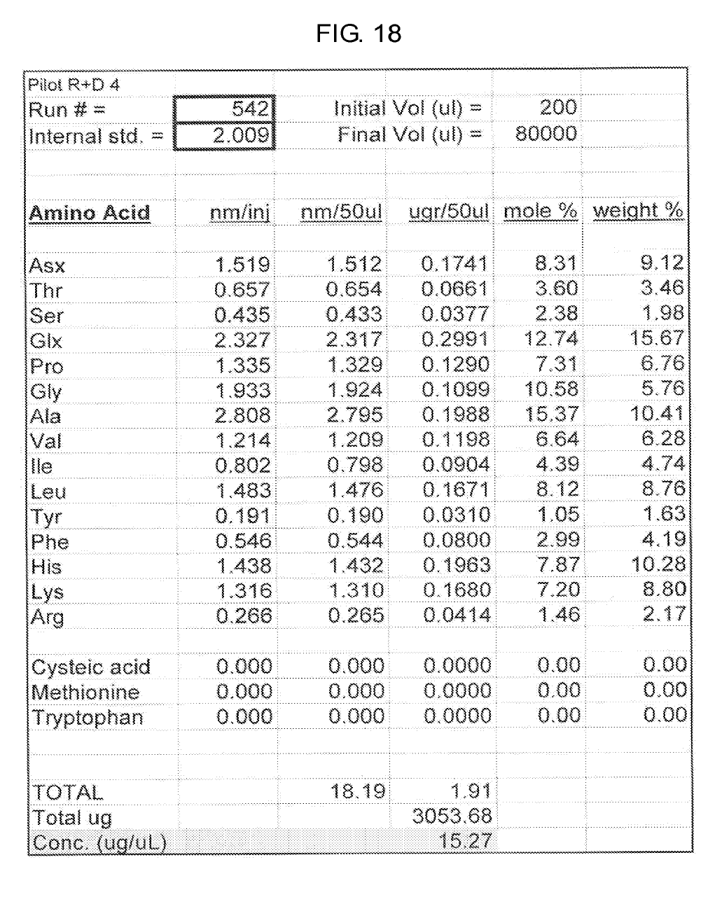

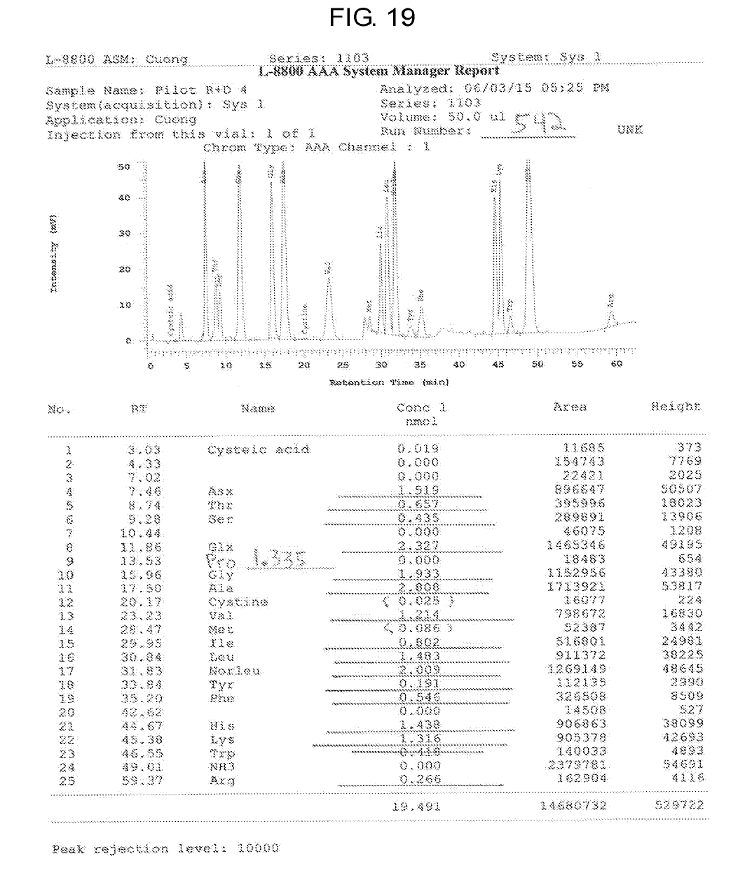

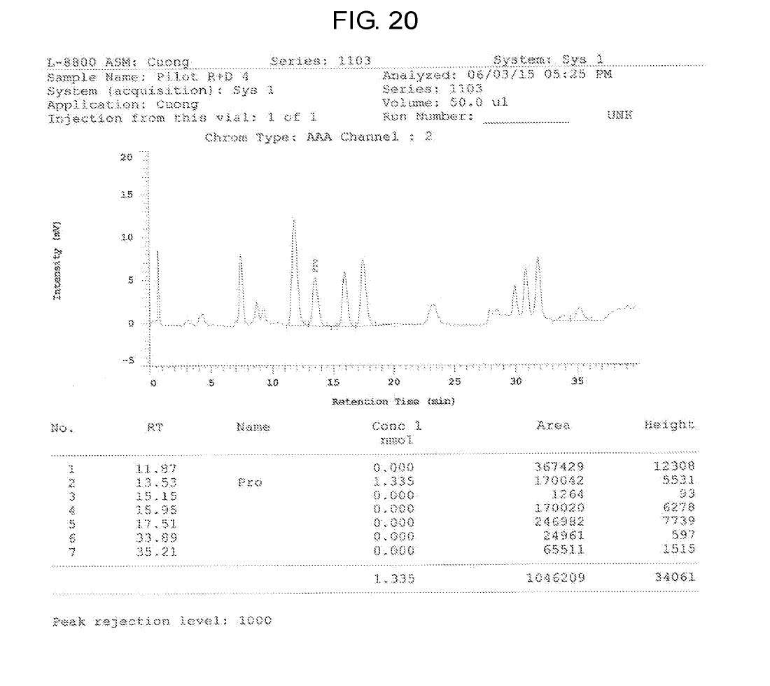

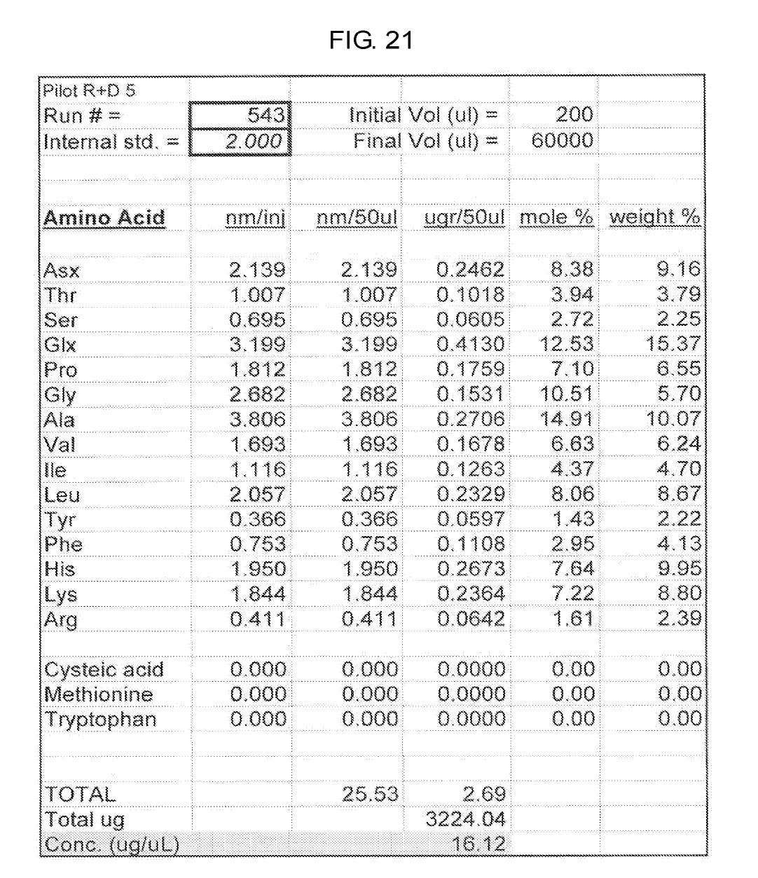

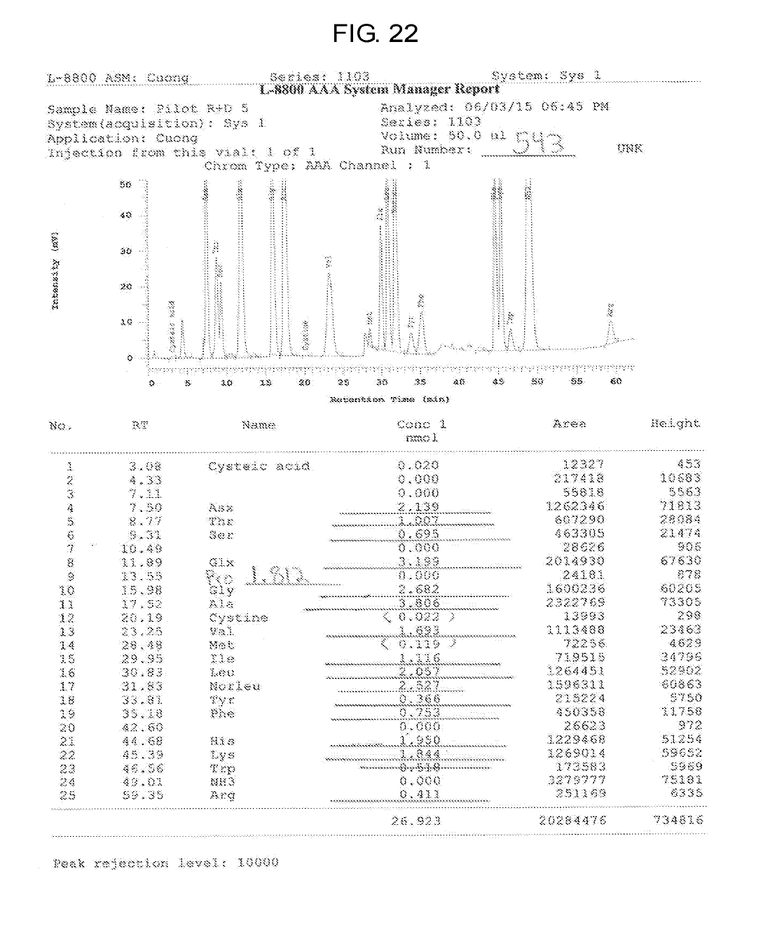

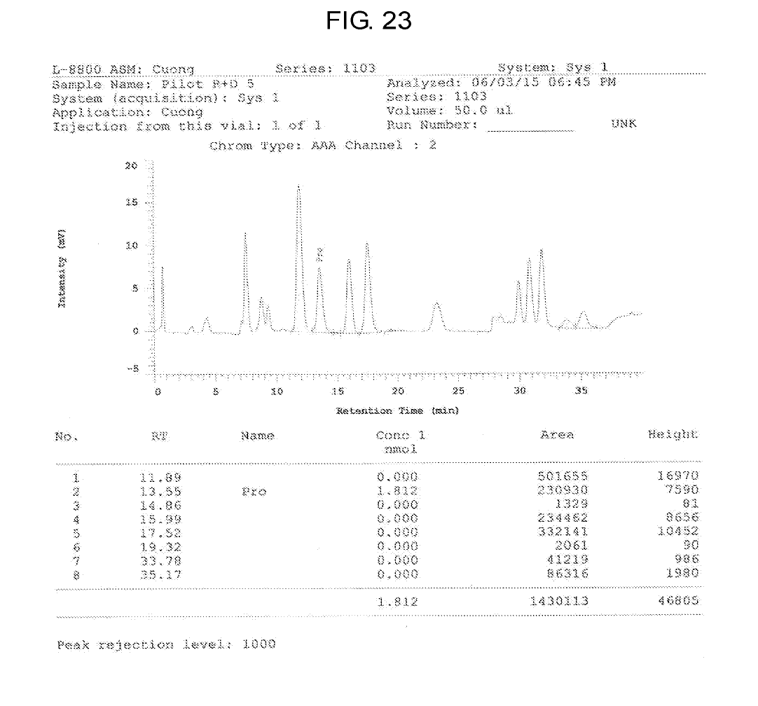

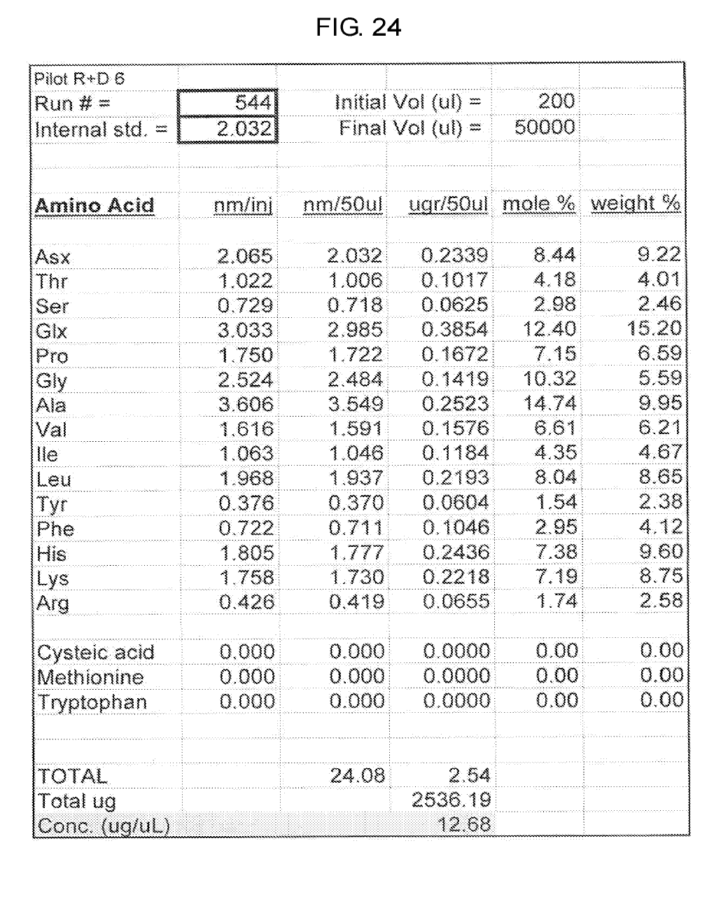

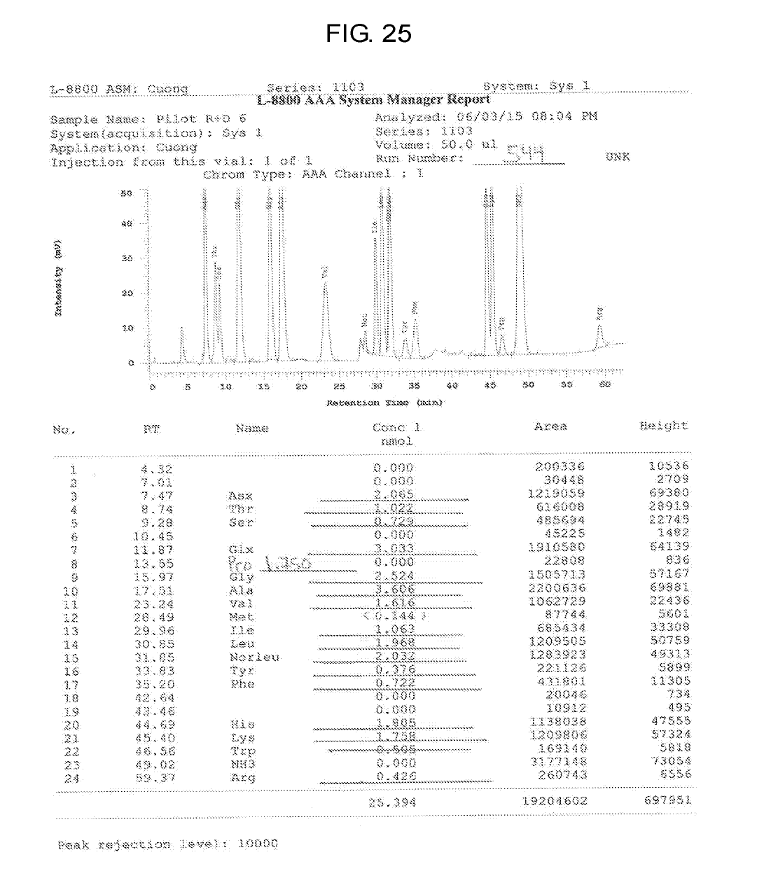

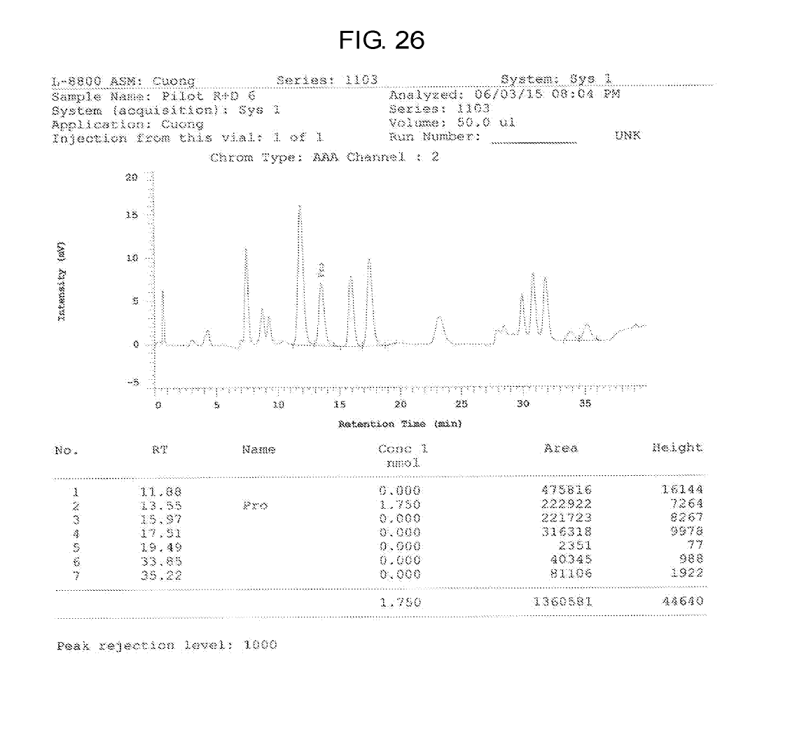

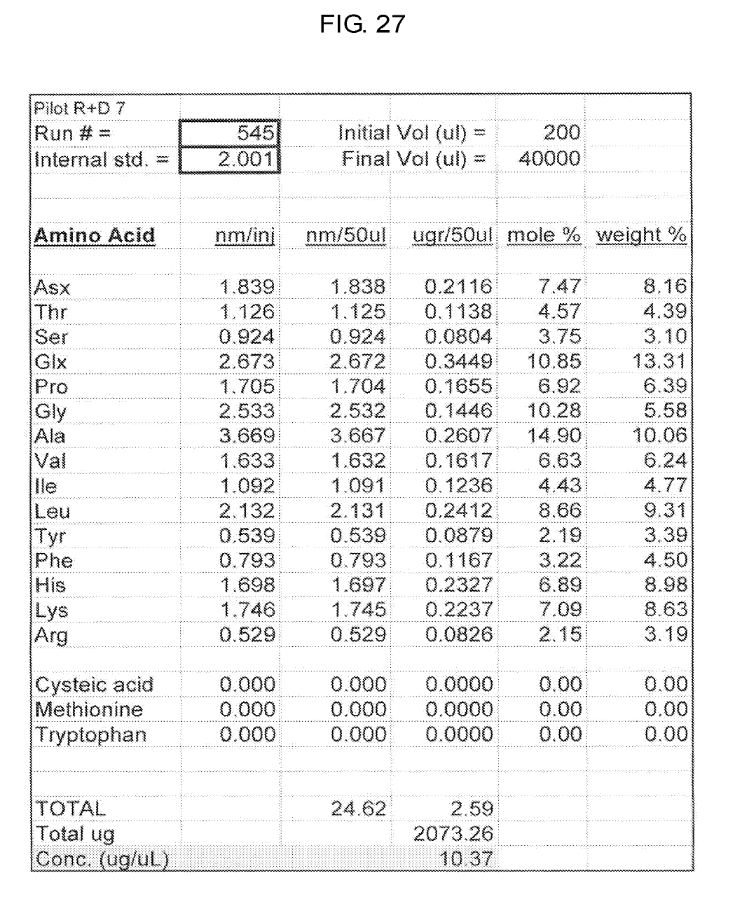

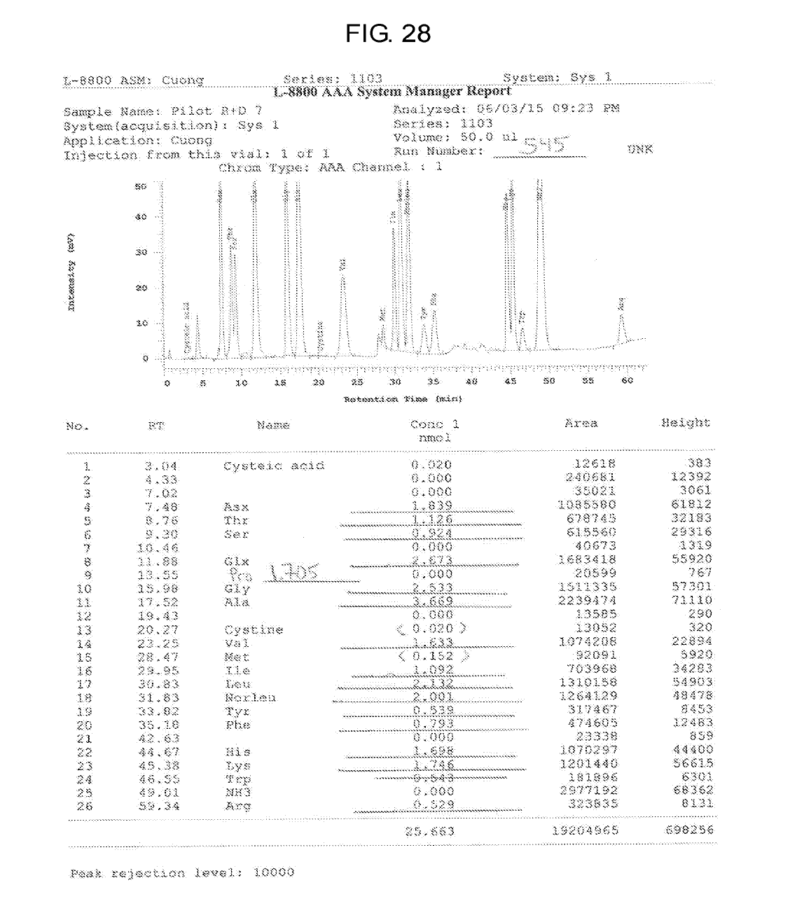

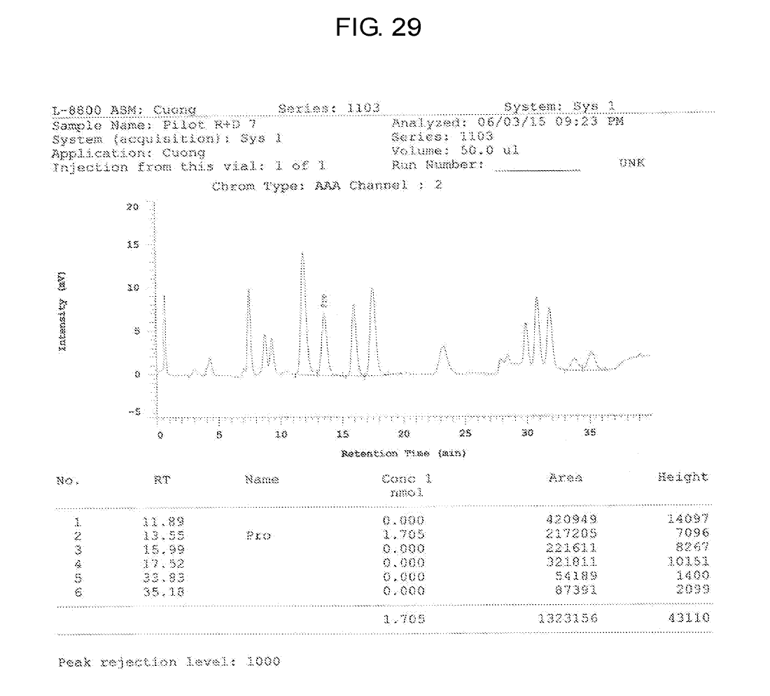

The following example describes the amino acid analysis of the insect products (see e.g., FIG. 14-FIG. 29).

Procedure:

(1) Transfer 200 microliter (μl) of sample to hydrolysis tube.

(2) Perform Liquid Phase Hydrolysis of sample. 200 μl of a solution of 6 N HCl/1% phenol was added to the sample in the hydrolysis tube and allowed to hydrolyze at 110° C. for 24 hours; the sample was then dried.

(3) Dissolve in norleucine (NorLeu) dilution buffer to final volume as indicated.

(4) Vortex; spin down; load 50 μl.

Note: Each 50 μl injection=2.0 nanomole (nmol) NorLeu.

Data generated can be seen in FIG. 14-FIG. 30. The figures show a series of data diagrams describing the amino acid analysis of the products at various stages of process. The samples are named 3=Sup (sample following enzyme digestion but prior to filtration), 4=Micro Filter (sample after micro filtration), 5=10 kD (sample after microfiltration and ultrafiltration through 10 kD filter), 6=5 kD (sample after microfiltration and ultrafiltration through 5 kD filter), and 7=3 kD (sample after microfiltration and ultrafiltration through 3 kD filter). The ratio of the highlighted values for amino acid concentration for Sample 4 vs. Sample 3 show that the proteins were collected from the filtration at a relatively high yield of 78.6%. Samples 5-7 were collected from the permeate of the ultrafiltration step using successively finer filters. They indicate that even at the 3 kD level, some protein was passing through the filters and thus being lost. This implies that smaller pore sizes can be used to increase protein yield during post-microfiltration, aqueous-based concentration processes.

### Example 6: Amino Acid Analysis (II)

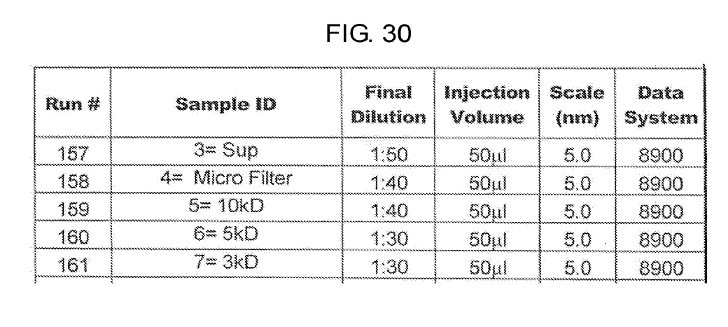

The following example describes the amino acid analysis of the insect products (see e.g., FIG. 30). Methods are as described in Example 5, unless noted otherwise.

Procedure:

(1) Transfer 200 μl of sample to fresh tube; add 50 μl 10% Sulfosalicylic Acid (SSA).

(2) Vortex; let sit for 15 minutes at room temperature.

(3) Freeze overnight; thaw; centrifuge.

(4) Dilute S-2-Aminoethyl-L-cysteine (AE-Cys) diluent to final dilution as indicated.

(5) Vortex; centrifuge; inject 50 μl.

Note: Each 50 μl injection=4.88 (1:50), 4.84 (1:40), 4.79 (1:30) nmol AE-Cys (see e.g., FIG. 30).

### Example 7: Protease/Peptidase Cocktail

This Example shows the protease/peptidase cocktail used for digestion.

A neutral protease/peptidase cocktail was used, both dosed in the slurry at 1% (w/w). The protease used was a fungal protease from Aspergillus oryzae at a strength of 800,000 HUT/g and the peptidase was from the same bacterial source at a strength of 500 LAPU/g. It was found that the pH of the raw crickets was 6.5+/−0.5, so neutral proteases were used. It would also be feasible, to use an acid or alkaline-stable protease by first adjusting the pH of the slurry, adding the enzyme, digesting, and then adjusting the pH back to a palatable range for human consumption.

### Example 8: Enzyme Hydrolysis Trials

This example describes two enzyme hydrolysis trials using freshly ground crickets suspended in deionized water, and the corresponding amount of enzyme was added. The mixed samples were vacuum-sealed in individual polyethylene bags, heated in a temperature controlled water bath for varying amounts of time at 45° C., cooled, and analyzed.

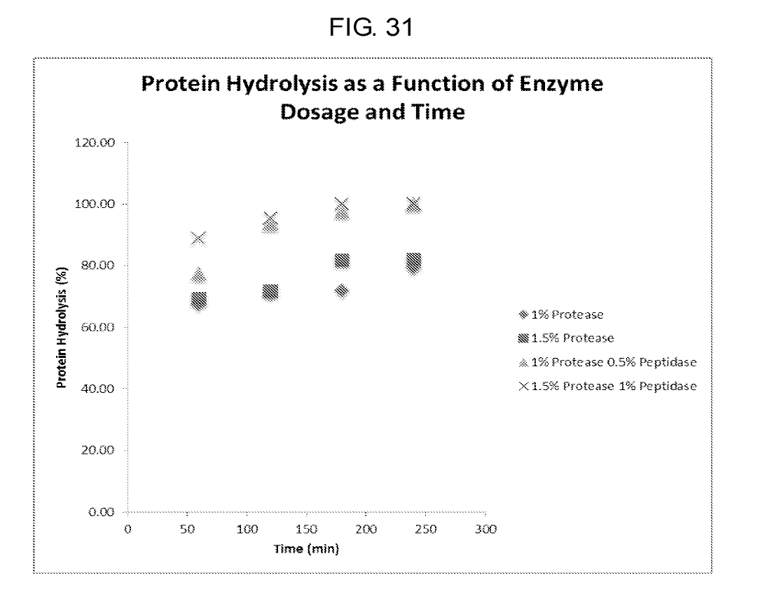

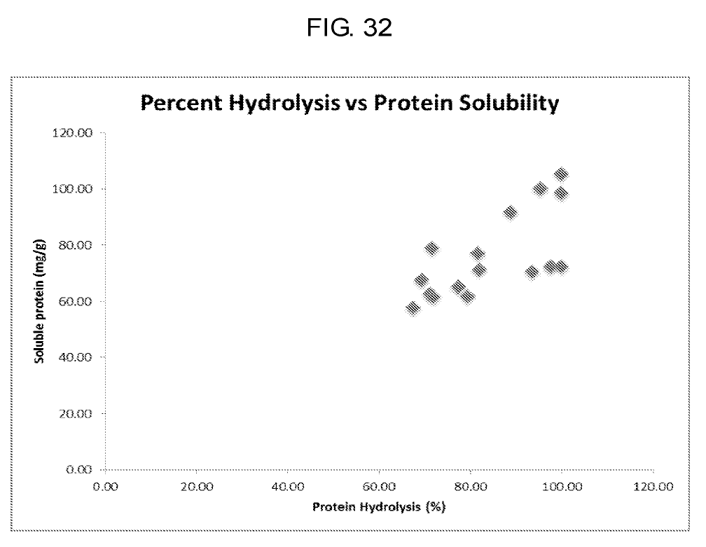

At a constant temperature of 45° C., cricket puree (50 g) at 3:1 water to cricket ratio, protease A 800,000 HUT, and peptidase 500 LAPU/g were incubated. See e.g., FIG. 31 and FIG. 32 for charts generated from TABLE 1.

TABLE 1
Hydrolysis data generated from varying protease, peptidase, and incubation time.

| | | | Incubation | Protease | | | | Soluble |
|---|---|---|---|---|---|---|---|---|
| | Protease | Peptidase | Time | Enzyme | Peptidase | | % | Protein |
| Sample # | Enzyme % | Enzyme % | (Minutes) | (g) | Enzyme (g) | pH | Hydrolysis | (mg/g) |
| 1 | 1.00% | 0.00% | 60 | 0.50 | 0.00 | 5.19 | 67.53 | 57.70 |
| 2 | 1.00% | 0.00% | 120 | 0.50 | 0.00 | 5.20 | 71.11 | 62.79 |
| 3 | 1.00% | 0.00% | 180 | 0.50 | 0.00 | 5.22 | 71.91 | 61.59 |
| 4 | 1.00% | 0.00% | 240 | 0.50 | 0.00 | 5.08 | 79.36 | 61.83 |
| 5 | 1.50% | 0.00% | 60 | 0.75 | 0.00 | 5.22 | 69.32 | 67.69 |
| 6 | 1.50% | 0.00% | 120 | 0.75 | 0.00 | 5.23 | 71.71 | 79.01 |
| 7 | 1.50% | 0.00% | 180 | 0.75 | 0.00 | 5.23 | 81.75 | 77.18 |
| 8 | 1.50% | 0.00% | 240 | 0.75 | 0.00 | 5.06 | 82.05 | 71.31 |
| 9 | 1.00% | 0.50% | 60 | 0.50 | 0.25 | 5.23 | 77.38 | 65.08 |
| 10 | 1.00% | 0.50% | 120 | 0.50 | 0.25 | 5.27 | 93.59 | 70.66 |
| 11 | 1.00% | 0.50% | 180 | 0.50 | 0.25 | 5.33 | 97.66 | 72.39 |
| 12 | 1.00% | 0.50% | 240 | 0.50 | 0.25 | 5.17 | 100.00 | 72.43 |
| 13 | 1.50% | 1.00% | 60 | 0.75 | 0.50 | 5.21 | 88.91 | 91.84 |
| 14 | 1.50% | 1.00% | 120 | 0.75 | 0.50 | 5.28 | 95.38 | 100.11 |
| 15 | 1.50% | 1.00% | 180 | 0.75 | 0.50 | 5.37 | 100.00 | 105.34 |
| 16 | 1.50% | 1.00% | 240 | 0.75 | 0.50 | 5.17 | 100.00 | 98.51 |
| 17 (Control) | 0.00% | 0.00% | 0 | 0.00 | 0.00 | 5.22 | | 19.81 |

FIG. 31-32 show the efficacy of fungal protease at various dosages and in conjunction with fungal peptidase in hydrolyzing cricket protein. It was found that the addition of peptidase drastically increased the solubility of the cricket protein.

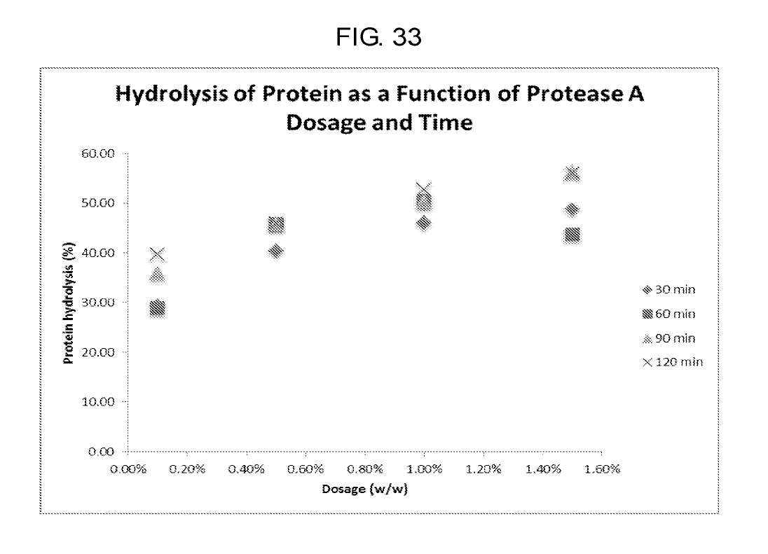

Another experiment measuring percent hydrolysis and protein solubility was performed as a function of enzymes, protease A or Flavorpro, as a function of dosage and time. FIG. 32-FIG. 33 show the efficacy of two types of fungal protease at various times and dosage levels in hydrolyzing cricket protein. The mixed samples were vacuum-sealed in individual polyethylene bags, heated in a temperature controlled water bath for varying amounts of time at 45° C., cooled, and analyzed.

TABLE 2
Hydrolysis and protein solubility data generated from protease A and Flavorpro enzymes
with varying dosages and incubation times.

| | | | Incubation | | | | | | Soluble |
|---|---|---|---|---|---|---|---|---|---|
| | | | Time | Temperature | Cricket | | | % | Protein |
| Sample # | Enzyme | Dosage | (Minutes) | (C.) | Puree (g) | Enzyme (g) | pH | Hydrolysis | (mg/g) |
| 1 | Protease A 500,000 HUT/g | 0.10% | 30 | 45 | 50.00 | 0.05 | 4.88 | 29.35 | 35.66 |
| 2 | Protease A 500,000 HUT/g | 0.50% | 30 | 45 | 50.00 | 0.25 | 4.78 | 40.43 | 43.85 |
| 3 | Protease A 500,000 HUT/g | 1.00% | 30 | 45 | 50.00 | 0.50 | 4.72 | 46.06 | 51.80 |
| 4 | Protease A 500,000 HUT/g | 1.50% | 30 | 45 | 50.00 | 0.75 | 4.77 | 48.83 | 60.14 |
| 5 | Protease A 500,000 HUT/g | 0.10% | 60 | 45 | 50.00 | 0.05 | 4.98 | 28.95 | 33.15 |
| 6 | Protease A 500,000 HUT/g | 0.50% | 60 | 45 | 50.00 | 0.25 | 4.83 | 45.82 | 47.45 |
| 7 | Protease A 500,000 HUT/g | 1.00% | 60 | 45 | 50.00 | 0.50 | 4.80 | 50.41 | 54.91 |
| 8 | Protease A 500,000 HUT/g | 1.50% | 60 | 45 | 50.00 | 0.75 | 4.77 | 43.76 | 61.57 |
| 9 | Protease A 500,000 HUT/g | 0.10% | 90 | 45 | 50.00 | 0.05 | 4.88 | 36.00 | 37.01 |
| 10 | Protease A 500,000 HUT/g | 0.50% | 90 | 45 | 50.00 | 0.25 | 4.91 | 45.82 | 45.62 |
| 11 | Protease A 500,000 HUT/g | 1.00% | 90 | 45 | 50.00 | 0.50 | 4.73 | 50.26 | 55.28 |
| 12 | Protease A 500,000 HUT/g | 1.50% | 90 | 45 | 50.00 | 0.75 | 4.80 | 56.51 | 63.77 |
| 13 | Protease A 500,000 HUT/g | 0.10% | 120 | 45 | 50.00 | 0.05 | 5.00 | 39.72 | 39.83 |
| 14 | Protease A 500,000 HUT/g | 0.50% | 120 | 45 | 50.00 | 0.25 | 4.96 | 45.90 | 51.89 |
| 15 | Protease A 500,000 HUT/g | 1.00% | 120 | 45 | 50.00 | 0.50 | 4.82 | 52.71 | 57.08 |
| 16 | Protease A 500,000 HUT/g | 1.50% | 120 | 45 | 50.00 | 0.75 | 4.78 | 56.04 | 65.29 |
| 17 | Flavorpro | 0.10% | 30 | 45 | 50.00 | 0.05 | 4.91 | 28.39 | 35.54 |
| 18 | Flavorpro | 0.50% | 30 | 45 | 50.00 | 0.25 | 4.89 | 39.09 | 42.37 |
| 19 | Flavorpro | 1.00% | 30 | 45 | 50.00 | 0.50 | 4.94 | 42.18 | 45.20 |
| 20 | Flavorpro | 1.50% | 30 | 45 | 50.00 | 0.75 | 4.86 | 52.71 | 62.44 |
| 21 | Flavorpro | 0.10% | 60 | 45 | 50.00 | 0.05 | 4.89 | 29.35 | 35.61 |
| 22 | Flavorpro | 0.50% | 60 | 45 | 50.00 | 0.25 | 4.89 | 42.65 | 47.80 |
| 23 | Flavorpro | 1.00% | 60 | 45 | 50.00 | 0.50 | 4.96 | 54.14 | 51.65 |
| 24 | Flavorpro | 1.50% | 60 | 45 | 50.00 | 0.75 | 5.04 | 61.98 | 61.99 |
| 25 | Flavorpro | 0.10% | 90 | 45 | 50.00 | 0.05 | 4.88 | 33.54 | 40.00 |
| 26 | Flavorpro | 0.50% | 90 | 45 | 50.00 | 0.25 | 4.92 | 50.73 | 51.02 |
| 27 | Flavorpro | 1.00% | 90 | 45 | 50.00 | 0.50 | 4.98 | 55.80 | 55.20 |
| 28 | Flavorpro | 1.50% | 90 | 45 | 50.00 | 0.75 | 4.99 | 64.59 | 65.54 |
| 29 | Flavorpro | 0.10% | 120 | 45 | 50.00 | 0.05 | 4.98 | 38.69 | 40.01 |
| 30 | Flavorpro | 0.50% | 120 | 45 | 50.00 | 0.25 | 5.07 | 51.13 | 51.87 |
| 31 | Flavorpro | 1.00% | 120 | 45 | 50.00 | 0.50 | 5.06 | 54.69 | 54.42 |
| 32 | Flavorpro | 1.50% | 120 | 45 | 50.00 | 0.75 | 4.98 | 57.94 | 64.41 |
| 33 | Control | 0 | 0 | 0 | 0 | 0 | 5.07 | 0 | 25.71 |

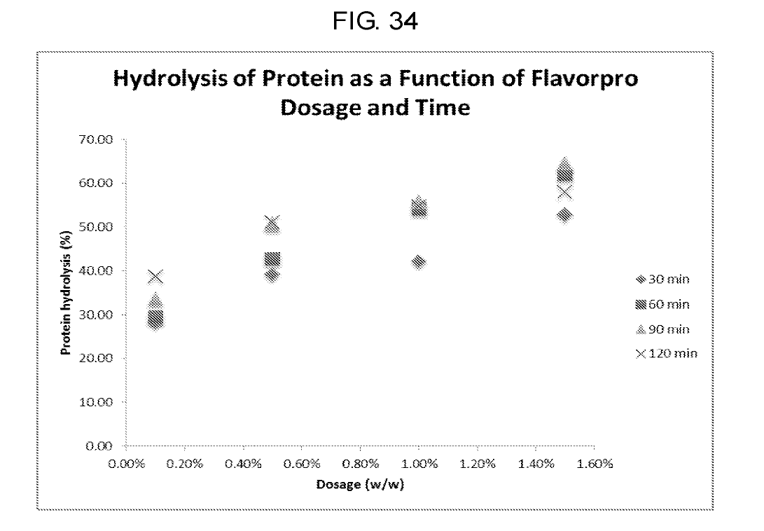

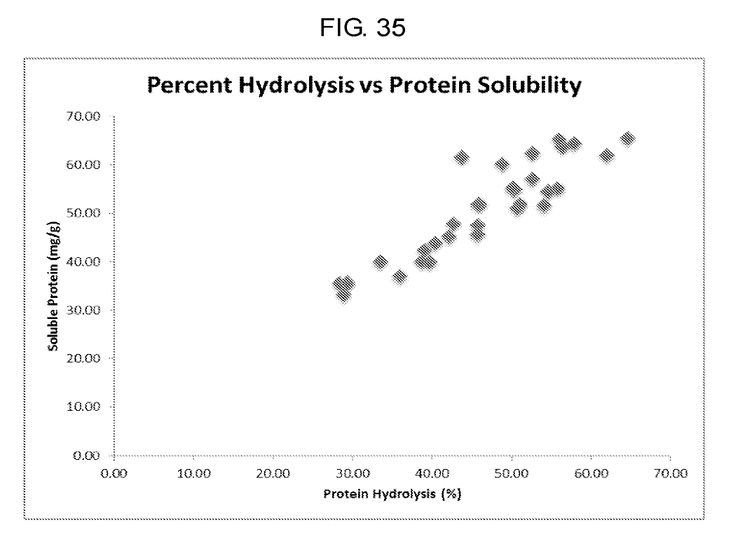

See e.g., FIG. 33, FIG. 34, and FIG. 35 for charts generated from TABLE 2.

### Example 9: Protein Characterization

The following example shows the molecular weights of the proteins in various stages of the manufacturing process.

This example produced three images characterizing the molecular weight of the proteins as they go from raw crickets through digestion and filtration.

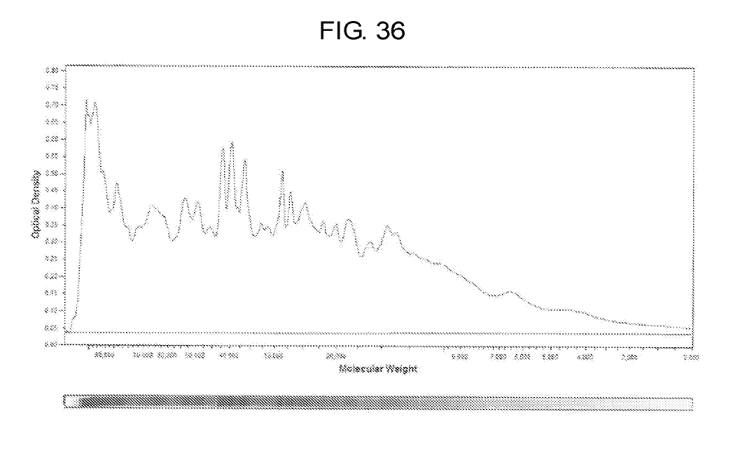

The molecular weight profile of the “raw slurry” sample can be seen in FIG. 36. Gel electrophoresis results showing wide range of molecular sizes for native cricket protein.

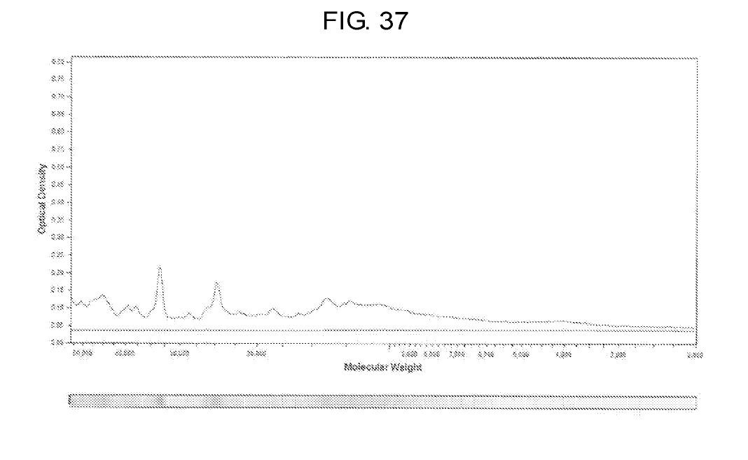

The molecular weight profile of the “digested slurry” can be seen in FIG. 37. Gel electrophoresis results showing substantial decrease in average molecular size of cricket protein. The two peaks in the 20-40 kDa range represent the added peptidase and protease enzymes.

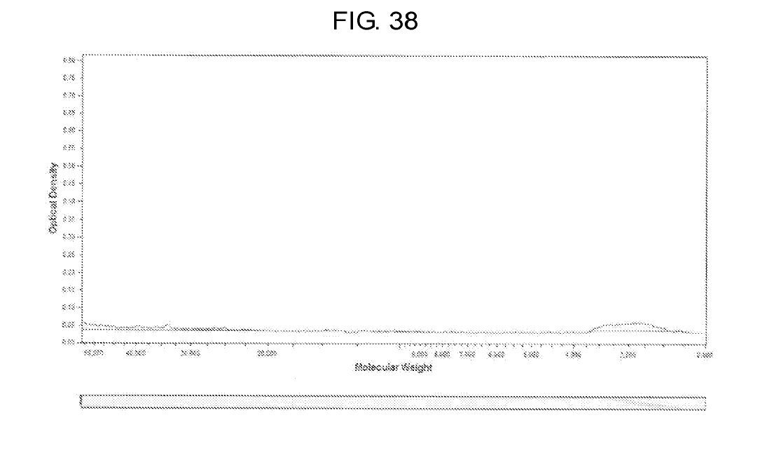

The molecular weight profile of the “cleaned” sample can be seen in FIG. 38. Gel electrophoresis results showing that the digested and microfiltered samples contain primarily protein in the 2-4 kDa range.

### Example 10: Nanofiltration or Reverse Osmosis

The following example shows that nanofiltration or reverse osmosis increases protein content.

The rationale is that according to the data on the molecular weight of the proteins after digestion, some protein may be lost during the ultrafiltration step, because some of the proteins are small enough to pass through those filters. Because crickets do not have the same high concentrations of ash and sugars as dairy, for instance, it is possible to forego the ultrafiltration step and skip to nanofiltration or reverse osmosis, which will remove water, but prevent even very small proteins from escaping.

1-23. (canceled)

24. A method for producing an insect product, the method comprising:
wet-grinding, grinding, or shearing at least one insect into a paste, puree, or powder,
diluting the paste, puree, powder, or dried insect with a composition comprising water forming an insect slurry;
adding a composition comprising an enzyme into the insect slurry forming an enzyme-containing insect slurry;
microfiltering the enzyme-containing insect slurry, wherein the pore size of the microfiltration membrane is sufficient to retain lipids or insoluble sediment, wherein proteins are collected in a permeate; and
ultrafiltering of the permeate, wherein the pore size of the filter membrane is sufficient to retain proteins and peptides comprising solid insect matter particles.

25. The method of claim 24, wherein ultrafiltring is used to remove particles less than about 0.5 μm or between about 0.007 μm and about 0.5 μm.

26. The method of claim 24, wherein the enzyme is added in a sufficient quantity to solubilize or partially solubilize the insect, hydrolyze proteins, or to digest the protein component of the slurry.

27. The method of claim 24, further comprising drying the permeate to form a dried insect product.

28. The method of claim 24, further comprising:
heating the slurry and composition comprising the enzyme for a period of time sufficient to at least one of the following:
partially solubilize the protein present in the insect;
liberate the protein from chitin; or
liberate the protein from any other macromolecules to which the protein is bound.

29. The method of claim 24, further comprising heating the enzyme-containing insect slurry to between about 45° C. and 60° C. prior to microfiltering.

30. The method of claim 24, wherein the enzyme-containing insect slurry comprises at least one of:
a neutral enzyme;
a protease and peptidase cocktail;
a protease from Aspergillus oryzae at a strength of 800,000 HUT/g;
or a peptidase Aspergillus oryzae at a strength of 500 LAPU/g.

31. The method of claim 24, wherein the enzyme-containing insect slurry includes at least one or more of:
Bromelain (Ananas comorus stem);
Papain (Carica papaya);
Peptidase (Aspergillus oryzae);
Peptidase (Aspergillus melleus);
Protease (Aspergillus niger);
Protease (Bacillus licheniformis);
Protease (Bacillus subtilis);
Protease (Aspergillus oryzae),
protease A, or
Flavorpro (peptidase).

32. The method of any one of claim 24, further comprising drying the permeate to form a dried insect product.

33. A method for producing an insect product, the method comprising:
providing an insect;
grinding, wet-grinding, or shearing the insect into an insect paste or powder;
diluting the insect paste or powder with a composition comprising water forming an insect slurry;
adding a composition comprising an enzyme to the insect slurry forming an enzyme-containing insect slurry;
microfiltering the enzyme-containing insect slurry, wherein the pore size of the microfiltration membrane is sufficient to retain lipids and insoluble sediment, wherein proteins are collected in the permeate; and
nanofiltering of the permeate, wherein the pore size of the filter membrane is sufficient to retain proteins and peptides.

34. The method of claim 33, further comprising heating the enzyme-containing insect slurry to between about 45° C. and 60° C. prior to microfiltering.

35. The method of claim 33, wherein the nanofiltring is used to remove particles less than about 0.01 μm or between about 0.0005 μm and about 0.01 μm.

36. The method of claim 33, wherein the slurry comprises at least one of:
a neutral enzyme;
a protease and peptidase cocktail;
a protease from Aspergillus oryzae at a strength of 800,000 HUT/g; or a peptidase Aspergillus oryzae at a strength of 500 LAPU/g.

37. The method of claim 33, wherein the enzyme includes at least one or more of:
Bromelain (Ananas comorus stem);
Papain (Carica papaya);
Peptidase (Aspergillus oryzae);
Peptidase (Aspergillus melleus);
Protease (Aspergillus niger);
Protease (Bacillus licheniformis);
Protease (Bacillus subtilis);
Protease (Aspergillus oryzae),
protease A, or
Flavorpro (peptidase).

38. The method of claim 33, further comprising adding at least one of:
cocoa, vanilla, cinnamon, natural flavor extracts, hydrocolloid gums, optionally, xanthan, guar, or gum acacia; stevia, sucralose, sugar alcohol, monkfruit extract, salt, lecithin, mono/diglycerides, or lipid emulsifiers.

39. The method of claim 33, wherein the particle size of the dried insect powder, insect puree, or insect paste is about 10 μm-200 μm.

40. The method of claim 33, wherein diluting the insect paste or powder includes diluting with water between a 1:1 dilution of cricket to water by mass and a 1:30 dilution of cricket to water by mass.

41. The method of any one of claim 33, further comprising drying the permeate to form a dried insect product.

42. An insect product comprising: a composition derived from at least one insect, comprising solid insect particles, wherein the insect product has
a protein content of about 90% to about
99%; a fat content of about 0% to about
50%;
a carbohydrate content of about 0% to about 50%;
an ash content of about 0% to about 5%; and
the solid insect particles have an average particle size between about 0.001 μm and about 100 μm or between about 0.01 μm and about 10 μm.

43. The insect product of claim 42, further comprising at least one of:
cocoa, vanilla, cinnamon, natural flavor extracts, hydrocolloid gums, optionally, xanthan, guar, or gum acacia; stevia, sucralose, sugar alcohol, monkfruit extract, salt, lecithin, mono/diglycerides, or lipid emulsifiers.
